(19) United States
(12) Patent Application Publication
(10) Pub. No.: US 2026/0277981 A1
(43) Pub. Date: Sep. 17, 2026

(54) SYSTEM

(71) Applicant: SoftBank Group Corp., Tokyo (JP)

(72) Inventor: Rin NAGANO, Tokyo (JP)

(73) Assignee: SoftBank Group Corp., Tokyo (JP)

(21) Appl. No.: 19/546,506

(22) Filed: Feb. 23, 2026

Related U.S. Application Data
(60) Provisional application No. 63/772,114, filed on Mar. 14, 2025.

(51) Int. Cl. G06F 16/34; G06F 16/31; G06F 40/242; G06F 40/268

(52) U.S. Cl. CPC G06F 16/345; G06F 16/31; G06F 40/242; G06F 40/268

(57) ABSTRACT

A system includes a processor configured to analyze a text of a news article to identify a subject of the article, important keywords, related persons and organizations, and events; identify, using pre-learned biased language patterns, specific expressions in the news article and evaluate a degree of bias of the article; identify information sources cited in the news article, compare past reliability of the information sources with a database to calculate a reliability score, and confirm whether information cited in the article is consistent with other reliable information sources; analyze a context and wording of the news article to classify an emotional tone as positive, negative, or neutral based on scoring using an emotion dictionary and classification using a machine learning model; and generate visualization data representing analysis results including at least a heat map indicating a degree of bias and a chart indicating the emotional tone.

### CROSS-REFERENCE TO RELATED APPLICATION

This application claims the benefit of U.S. Provisional Application No. 63/772,114, filed on Mar. 14, 2025, pursuant to 35 U.S.C. § 119(e), the entire contents of which are incorporated herein by reference.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

In recent years, a large volume of news articles has become instantly accessible through online media platforms, social networks, and news aggregation services. However, readers often encounter articles that contain hidden bias, selective emphasis of particular viewpoints, and emotionally charged language, as well as citations to information sources of varying and sometimes questionable reliability. Conventional news delivery systems primarily focus on presenting content without systematically analyzing the article text for subject matter, bias, reliability of cited sources, or emotional tone. As a result, a reader is required to manually evaluate whether an article is biased toward a specific position, whether the cited sources are trustworthy, and what emotional influence the wording of the article may exert. This manual evaluation is difficult, time-consuming, and highly dependent on the reader's media literacy and prior knowledge. Accordingly, there is a need for a system that automatically analyzes news articles using natural language processing to identify the subject, important keywords, related persons and organizations, and events, that detects biased language patterns and quantifies a degree of bias, that evaluates the reliability of cited information sources based on past reliability data and cross-checking with other reliable sources, that determines an emotional tone of the article, and that visualizes the analysis results in an intuitive manner, thereby supporting a reader in making a calm and informed judgment about the credibility and bias of news articles.

### SUMMARY

In order to solve the above-described problems, an aspect of the present invention provides a system comprising a processor, wherein the processor is configured to analyze a text of a news article using natural language processing to identify a subject of the article, important keywords, related persons and organizations, and events, to identify, using pre-learned biased language patterns, specific expressions in the news article and evaluate a degree of bias of the article, to identify information sources cited in the news article, compare past reliability of the information sources with a database to calculate a reliability score, and confirm whether information cited in the article is consistent with other reliable information sources, to analyze a context and wording of the news article to classify an emotional tone of the news article as positive, negative, or neutral based on scoring using an emotion dictionary and classification using a machine learning model, and to generate visualization data representing analysis results including at least a heat map indicating a degree of bias and a chart indicating the emotional tone. In one embodiment, the processor is configured to extract words and phrases from the text of the news article by performing morphological analysis and to identify the subject of the news article by performing topic modeling, thereby clarifying a theme on which the news article focuses and enabling a reader to understand contents of the news article more deeply. In another embodiment, the processor is configured to analyze language expressions in the news article using the pre-learned biased language patterns to identify expressions that potentially emphasize a specific viewpoint and to evaluate the degree of bias of the news article, thereby enabling a reader to assess whether the news article is biased toward a particular position and to obtain a clue for determining reliability of information in the news article.

The term “system” refers to a combination of hardware and software components, including at least one processor and associated memory, that cooperate to execute the functions described in the claims.

The term “processor” refers to one or more hardware processing units, such as a central processing unit (CPU), graphics processing unit (GPU), microcontroller, or any combination thereof, configured to execute instructions and perform the operations recited in the claims.

The term “news article” refers to an electronic text document that reports, explains, or comments on current or past events, topics, or issues, and that is typically published by a news organization, media outlet, or similar source.

The term “text of a news article” refers to the body of textual content of the news article, including a title, headings, paragraphs, and sentences, but excluding non-textual elements such as images, videos, and purely decorative content.

The term “natural language processing” refers to a set of computational techniques that enable the processor to analyze and interpret human language text, including but not limited to tokenization, part-of-speech tagging, syntactic analysis, semantic analysis, and topic modeling.

The term “subject of the article” refers to a main theme or central topic that the news article primarily addresses, such as a particular event, policy, issue, or entity.

The term “important keywords” refers to words or phrases extracted from the text of a news article that are determined, based on statistical, linguistic, or semantic criteria, to be highly representative of the article's subject, content, or main themes.

The term “related persons and organizations” refers to individuals, groups, companies, institutions, or other entities mentioned in the news article that are identified by the processor as being relevant to the article's subject or events.

The term “events” refers to occurrences or happenings described in the news article, such as incidents, actions, decisions, announcements, or developments that take place at a particular time or over a particular period.

The term “pre-learned biased language patterns” refers to linguistic expressions, templates, or features that have been determined in advance, for example by machine learning or rule-based analysis, to be indicative of potential bias, subjective emphasis, or partiality in text.

The term “specific expressions” refers to concrete phrases, sentences, or linguistic constructions in the text of a news article that match or are similar to the pre-learned biased language patterns.

The term “degree of bias” refers to a quantitative or qualitative measure that indicates an extent to which the text of a news article exhibits biased or one-sided language, emphasis, or framing with respect to a particular viewpoint or position.

The term “information sources” refers to external entities or references cited in a news article, including but not limited to websites, documents, organizations, reports, experts, or other publications from which information in the article is derived.

The term “past reliability” refers to historical information about an information source's accuracy, trustworthiness, or consistency, including records of verified correct information, misinformation incidents, or third-party evaluations.

The term “reliability score” refers to a numerical or categorical value computed by the processor that represents an evaluated level of trustworthiness or credibility of an information source or of a news article based on one or more criteria, including past reliability and cross-checking with other sources.

The term “database” refers to a structured data storage system, which may be implemented using one or more physical or logical storage devices, and which stores information such as past reliability data, article data, or analysis results, accessible by the processor.

The term “consistent with other reliable information sources” refers to a state in which information cited in a news article substantially agrees in content, such as facts or figures, with information provided by other sources that have been evaluated as having sufficiently high reliability scores.

The term “context” refers to surrounding text, including neighboring words, sentences, or paragraphs, and to the situational or semantic environment in which a particular expression in the news article appears.

The term “wording” refers to a choice and arrangement of words, phrases, and expressions used in the text of a news article, including stylistic and rhetorical elements.

The term “emotional tone” refers to an overall emotional character or sentiment expressed by the text of a news article, such as being positive, negative, neutral, or a combination thereof, as determined by the processor.

The term “emotion dictionary” refers to a collection of words and phrases associated with predefined emotional categories or sentiment scores, used by the processor to evaluate the emotional tone of text.

The term “machine learning model” refers to a computational model that has been trained on example data to automatically perform tasks such as classification, prediction, or scoring, including but not limited to neural networks, support vector machines, decision trees, and ensemble models.

The term “visualization data” refers to structured data generated by the processor that represents analysis results in a form suitable for graphical presentation, such as values, labels, coordinates, or mappings corresponding to graphical elements.

The term “heat map indicating a degree of bias” refers to a graphical representation in which regions or elements corresponding to parts of a news article are assigned colors or intensities that visually encode the degree of bias associated with those parts.

The term “chart indicating the emotional tone” refers to a graphical representation, such as a pie chart, bar chart, gauge, or similar visual, that depicts the classification or strength of the emotional tone of a news article based on analysis results.

The term “morphological analysis” refers to a natural language processing technique in which a text is segmented into minimal meaningful units, such as words or morphemes, and grammatical or part-of-speech information is assigned to those units.

The term “topic modeling” refers to a statistical or computational technique that discovers abstract topics from a collection of documents or from a single document, and that associates each document or segment of text with one or more topics based on patterns of word usage.

The term “language expressions in the news article” refers to sentences, phrases, and words that make up the textual content of the news article, including both objective statements and subjective or evaluative statements.

The term “specific viewpoint” refers to a particular position, stance, opinion, or perspective on an issue or subject that may be favored or emphasized by the wording of a news article.

The term “particular position” refers to a defined side, stance, or orientation in a debate, controversy, or issue, such as support for or opposition to a policy, person, organization, or idea.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

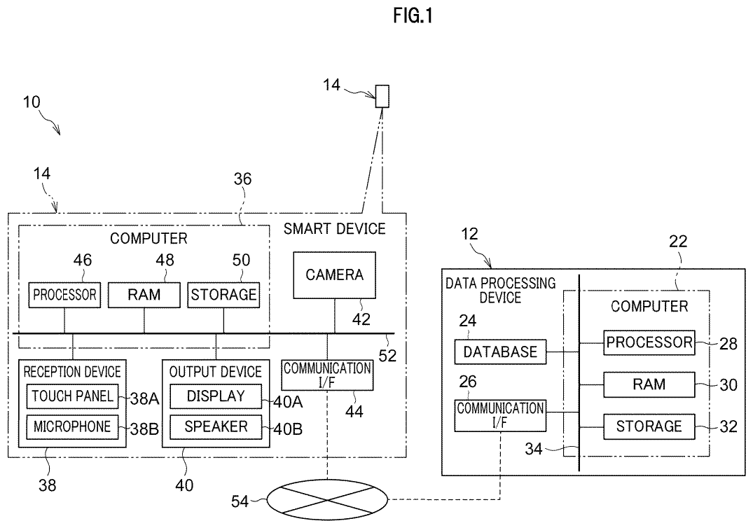

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

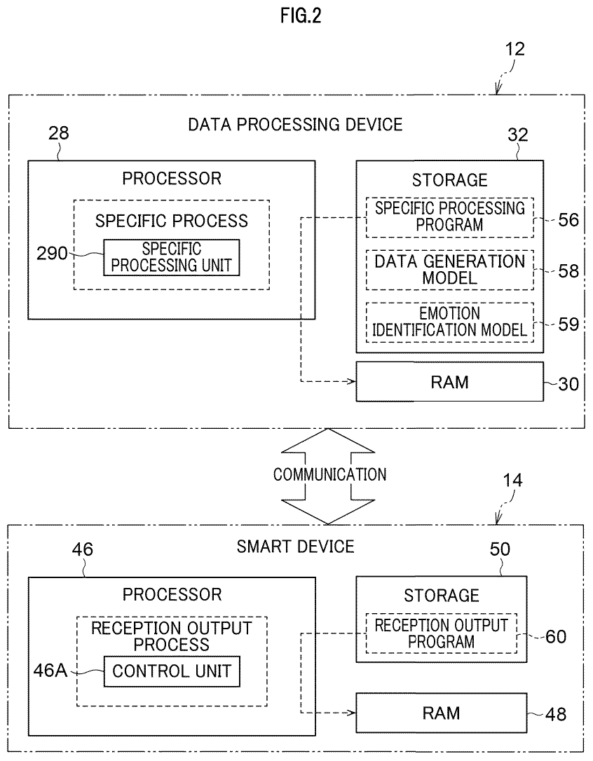

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented systems that analyze text-based information such as news articles typically treat bias detection, source reliability evaluation, and sentiment analysis as separate and loosely coupled tasks. In many implementations, these tasks are performed by independent software modules or external services that operate on static rule sets or pre-trained models, with limited or no feedback among the modules. As a result, such systems often suffer from several technical problems at the computing level.

First, traditional systems commonly store only raw text and high-level labels, without generating rich, structured intermediate representations that integrate topical information, linguistic patterns, source entities, and emotional features into a unified data model. This leads to inefficient processing pipelines in which the same text is repeatedly parsed and tokenized by different components, consuming redundant processor cycles and memory bandwidth. The absence of a shared, structured analysis-structured data layer inhibits optimized query processing, caching, and reuse of intermediate computation results across bias, reliability, and sentiment analyses.

Second, rule sets and model parameters used for bias detection and reliability scoring are typically static and manually configured. Updating these rules often requires expert intervention, offline retraining, and redeployment of software components. This rigid configuration model prevents the system from adapting to newly emerging linguistic patterns, novel forms of misinformation, or changes in the reliability of information sources. From a computer-technical perspective, this results in a system whose accuracy degrades over time and that cannot automatically reconfigure its processing logic in response to newly available data or models, thereby limiting robustness and scalability.

Third, many existing systems do not perform integrated processing that combines structured natural language processing outputs, source entity resolution, external search results, and user-facing visualization in a coordinated manner. Instead, they deliver partial outputs that require additional client-side processing or human interpretation. This fragmented architecture can lead to inefficient client-server communication, repeated transfers of large unstructured text payloads, and increased latency, because the server does not precompute compact, analysis-structured data optimized for visualization and interaction. Furthermore, explanatory information explaining why a given bias or reliability score was assigned is often either absent or generated using ad hoc heuristics, which hampers the transparency and usability of the system.

Fourth, while generative AI models are increasingly available via network-based interfaces, conventional analysis systems generally do not incorporate such models into the core processing pipeline in a structured, machine-consumable way. In many cases, any interaction with a generative AI model is restricted to ad hoc usage by human operators. As a consequence, systems fail to leverage generative AI models to systematically generate and refine rule sets, weighting schemes, and user-facing explanations. This results in a missed opportunity to automate part of the configuration and maintenance burden and to improve overall system performance through dynamic adaptation of computational parameters. Accordingly, there is a need for an improved computer-implemented system and server-side architecture that (i) generates and maintains unified analysis-structured data for each document, (ii) dynamically updates bias and reliability computation logic using generative AI models via prompt sentences, (iii) integrates multiple analytic indices into compact data structures optimized for visualization, and (iv) reduces redundant processing and communication overhead. Such a system should improve the functioning of the underlying computer by organizing processing steps into an efficient pipeline, reducing repeated parsing and analysis, enabling automatic reconfiguration of rule sets and parameters, and producing machine-optimized data structures for downstream visualization and interaction on client devices.

The specific processing by the specific processing unit 290 of the data processing device 12 in Example 1 is realized by the following means.

The present invention provides a server comprising a processor and a memory storing instructions, wherein the processor is configured to acquire document data and associated attribute data from multiple information distribution sources via a communication network, normalize and pre-process the document data, perform natural language processing on text contained in the document data to generate subject information and feature information, calculate a bias index by applying predefined expression patterns and a trained classification model to the feature information, identify cited information sources and calculate a reliability index based on past reliability records and external search results, analyze emotional expressions within the text to calculate an emotion index, integrate the bias index, the reliability index, and the emotion index into analysis-structured data, and provide the analysis-structured data via an external interface to a client device that generates graphical visualizations. This enables an improvement in the functioning of the computer system by reducing redundant text processing, organizing heterogeneous analytic outputs into a unified, machine-optimized data representation, and lowering communication overhead between the server and the client through compact, pre-aggregated analysis-structured data that directly supports efficient rendering of interactive visualizations and user interaction flows.

The present invention further provides a server comprising a processor and a memory storing instructions, wherein the processor is configured to automatically generate multiple prompt sentences directed to a generative AI model, the prompt sentences including at least a prompt sentence related to bias detection, a prompt sentence related to reliability evaluation, and a prompt sentence related to emotion analysis, transmit the prompt sentences to the generative AI model, receive responses that include language expressions representing analysis rule candidates, weighting schemes, and explanatory text, parse the responses to extract an expression pattern set and weighting rules, and register the expression pattern set and the weighting rules as configuration information used by the bias index calculation and the reliability index calculation. This enables dynamic adaptation and continuous refinement of server-side analytical logic, reducing the need for manual rule engineering, improving the accuracy and robustness of bias and reliability computation over time, and providing machine-generated explanatory text that can be stored with the analysis-structured data and presented to users in association with visualizations, thereby enhancing both computational efficiency and transparency of the computer-implemented analysis system.

The term “information distribution source” refers to any network-accessible provider of electronic document data, including but not limited to news providers, content aggregation services, or other servers that supply text-based information via a communication network.

The term “document data” refers to electronic data representing at least textual content and optionally including metadata such as a title, publication time, author identifier, category indicator, and a network resource locator.

The term “associated attribute data” refers to structured or semi-structured data linked to document data, including metadata values, source identifiers, topic indicators, timestamps, and other information describing properties of the document data.

The term “structured information storage” refers to a data storage component, such as a database system or a structured file repository, that stores document data and associated attribute data according to a predefined data schema enabling indexed access and query processing.

The term “subject information” refers to data representing at least one main topic or theme of a document, derived from natural language processing and statistical analysis of the document text.

The term “feature information” refers to data representing measurable characteristics of a document, including token sequences, topic distributions, term statistics, and other numerical or categorical features used as input to computational models.

The term “natural language processing” refers to a set of computer-implemented techniques for processing human language text, including tokenization, sentence segmentation, morphological analysis, parsing, named entity recognition, and topic modeling.

The term “morphological analysis” refers to a natural language processing technique that segments text into unit expressions such as words or morphemes and identifies base forms or part-of-speech categories of the unit expressions.

The term “unit expression sequence” refers to an ordered list of minimal linguistic units, such as tokens, words, or morphemes, obtained from a document by morphological analysis or tokenization.

The term “topic extraction” refers to a computational process that identifies one or more latent topics or themes in a collection of documents, for example by applying a probabilistic topic model to generate topic distributions for each document.

The term “topic distribution” refers to a data structure that assigns probability or weight values to a plurality of topics for a given document, indicating the relative relevance of each topic to the document.

The term “important expression” refers to a unit expression or phrase that is determined to be salient for representing the content of a document, for example based on term frequency, inverse document frequency, or topic-specific weight.

The term “predefined expression pattern” refers to a rule, regular expression, phrase list, or template that specifies linguistic forms associated with a particular type of bias, emphasis, or other semantic characteristic.

The term “trained classification model” refers to a machine-learned computational model that has been trained on labeled data to assign a class label or probability value to input feature information, such as a model for classifying bias levels of documents.

The term “bias index” refers to a numerical or categorical indicator computed for a document, representing a degree or type of bias inferred from expression patterns and feature information.

The term “citation candidate sentence” refers to a sentence or text segment in a document that is identified, based on linguistic markers or patterns, as potentially containing a reference to an information source.

The term “entity recognition” refers to a natural language processing technique that detects and classifies references to real-world entities, such as organizations, persons, or publications, in text.

The term “name normalization” refers to a process that converts multiple variant textual forms of an entity name into a common canonical representation, enabling consistent identification of the entity across documents.

The term “source identifier” refers to a data item that uniquely represents an information source, such as a normalized name, an internal key, or a combination thereof, used for linking to reliability records.

The term “past reliability record” refers to stored data describing historical characteristics of an information source, such as correctness assessments, error occurrences, or external evaluation results.

The term “external search result” refers to data returned from an external search service or information retrieval system in response to a query derived from document content, including at least result snippets and source indicators.

The term “reliability value” refers to a numerical or categorical indicator calculated for an information source or a document, representing an estimated level of trustworthiness based on past reliability records and external search results.

The term “reliability index” refers to a numerical or categorical indicator calculated for a document by aggregating reliability values of one or more identified information sources cited in the document.

The term “emotion dictionary” refers to a collection of lexical entries, each associated with one or more emotion categories or polarity values, used to score emotional properties of words or phrases in text.

The term “emotion index” refers to a numerical or categorical indicator representing an overall emotional characteristic of a document, such as an intensity or distribution of emotional tones.

The term “analysis-structured data” refers to a structured data representation that integrates multiple analytic outputs for a document, including at least the bias index, the reliability index, the emotion index, subject information, and feature information, in a machine-readable format.

The term “external interface” refers to a programmatic interface, such as an application programming interface, through which the server provides analysis-structured data to external devices or applications.

The term “visualization information” refers to data describing one or more graphical representations of analysis-structured data, including settings and parameters for rendering charts, graphs, or other visual elements.

The term “graphical display” refers to a visual representation rendered on a display device, such as a chart, graph, map, or diagram, generated based on visualization information.

The term “time-series display” refers to a graphical display that represents changes of one or more indices or values over time.

The term “distribution display” refers to a graphical display that represents a distribution of values or categories, such as a histogram, bar chart, or pie chart.

The term “correlation display” refers to a graphical display that represents relationships between two or more indices or variables, such as a scatter plot or a heat map.

The term “operation information” refers to data representing user input actions received from an input device, including selection, scrolling, filtering, or other interaction commands.

The term “article unit basis” refers to a mode of visualization or processing in which data is organized and presented per individual document or article.

The term “topic unit basis” refers to a mode of visualization or processing in which data is organized and presented per topic or subject category derived from topic extraction.

The term “index-range unit basis” refers to a mode of visualization or processing in which data is organized and presented for subsets of documents selected according to ranges of indices, such as bias index ranges or reliability index ranges.

The term “generative AI model” refers to a machine-learned model that generates new text or other content in response to input text, including large language models accessible through a network-based interface.

The term “prompt sentence” refers to an input text provided to a generative AI model, formulated to request generation of specific information such as analysis rules, weighting schemes, or explanatory text.

The term “query sentence” refers to a prompt sentence that is structured as a query requesting information or proposals related to a particular analysis task.

The term “analysis rule candidate” refers to a proposed rule or pattern, generated or suggested by a generative AI model, that is suitable for use in computational analysis such as bias detection or reliability evaluation.

The term “weighting rule” refers to a computational rule defining how to assign or combine weights for different features, indices, or information sources when calculating an index or aggregated value.

The term “expression pattern set” refers to a collection of expression patterns, such as phrases or regular expressions, that are used together to detect specific linguistic phenomena in text.

The term “user-oriented explanatory text” refers to textual information generated for presentation to an end user, explaining reasons for analysis results, including why particular bias, reliability, or emotion indices were assigned.

The term “configuration information” refers to data that specifies parameters, thresholds, rules, or models used by analysis processes, and that can be updated to modify the behavior of the system without changing executable code.

In one embodiment, a server executes a computer program stored in a memory and implemented, for example, using a general-purpose operating system on hardware including at least one processor, a main memory, a non-volatile storage device, a network interface, and a graphics controller. The server uses widely available software components, such as a relational database management system (for example, a SQL-based database), a web application framework (for example, a HTTP server with a REST framework), and natural language processing libraries (for example, a tokenizer, a morphological analyzer, and a topic modeling toolkit). The server further uses a machine learning framework, such as a numerical computation library or a neural network framework, to execute bias classification and emotion classification, and to communicate with an external generative AI model via an application programming interface.

In one embodiment, the server acquires document data and associated attribute data from multiple information distribution sources. The server uses a network interface and an HTTP client library to send requests to remote information sources, such as news feeds, content syndication endpoints, and other text-providing servers. The server receives hypertext data or structured feed data, parses the received data using a parsing library, and normalizes text encoding to a uniform character set. The server extracts text regions, such as article title fields and body text fields, and associated attribute data, such as time stamps, source identifiers, and category tags. The server stores the extracted data in a structured information storage, such as a relational table or a document-oriented data store, using a defined schema that associates each document record with attribute records and analysis records.

In one embodiment, the server analyzes article content stored in the structured information storage using natural language processing. The server uses a tokenization library or a morphological analyzer to split text into unit expression sequences. The server uses a part-of-speech tagger and a lemmatization module to convert tokens into normalized forms and to assign grammatical categories. The server generates feature information that includes at least token indices, token frequencies, n-gram counts, and syntactic dependency indicators stored as vectors or sparse matrices in a feature table. The server uses a topic modeling algorithm, such as Latent Dirichlet Allocation implemented in a numerical computation library, to calculate a topic distribution for each document. The server stores the topic distribution as a vector of floating point values associated with topic identifiers. The server designates one or more topics with maximum probability as subject information that characterizes the main theme of the document. This arrangement allows the server to compute subject information and feature information only once and reuse them across bias, reliability, and emotion computations, thereby reducing redundant parsing and tokenization and improving processing throughput.

In one embodiment, the server calculates a bias index for each document by combining predefined expression patterns and a trained classification model. The server stores a plurality of predefined expression patterns in a pattern table as text phrases and regular expressions associated with bias categories, such as dismissive language, exaggeration, and loaded terms. The server executes a pattern-matching engine that scans unit expression sequences, sentence boundaries, and character offsets to detect occurrences of the patterns. The server generates a pattern occurrence vector for each document, where each dimension corresponds to a pattern and stores the occurrence count or frequency. The server further constructs an input feature vector by concatenating the pattern occurrence vector, topic distribution, token statistics, and sentiment-related lexical features.

In one embodiment, the server executes a trained classification model implemented as a neural network. The server uses a feed-forward neural network with an input layer corresponding to the feature vector dimension, one or more hidden layers using rectified linear unit activation functions, and an output layer producing a scalar bias probability. The server stores learned parameters, such as weight matrices and bias vectors, in model storage and loads them into memory at run time. The server computes a forward pass by multiplying the input feature vector by the weight matrices, applying activation functions, and generating the output bias probability. The server converts the bias probability into a bias index by scaling and thresholding, and stores the bias index as a floating point value and an associated categorical label in the structured information storage.

In one embodiment, the server trains the bias classification neural network offline using a training dataset of labeled documents. The server uses a supervised learning algorithm, such as stochastic gradient descent or an adaptive optimization algorithm, to minimize a loss function, such as a binary cross-entropy loss between predicted bias probabilities and ground-truth labels. The server performs backpropagation to compute gradients of the loss with respect to model parameters, updates the weight matrices and bias vectors, and repeats training over multiple epochs. The server optionally uses data augmentation, such as synonym substitution or paraphrasing, to increase the diversity of training documents. This training process results in a model that captures complex interactions between patterns, topics, and lexical features that are not easily described by rule-based logic, thereby improving classification accuracy beyond manual rule sets.

In one embodiment, the server identifies cited information sources and calculates a reliability index. The server applies an entity recognition module, such as a named entity recognizer based on a sequence labeling model, to detect organization names, publication names, and person names in citation candidate sentences. The server performs name normalization by applying text normalization rules and an alias mapping table that maps variants of names to canonical identifiers. The server retrieves past reliability records associated with each source identifier from a reliability database. The server computes per-source reliability values by combining multiple attributes, such as historical accuracy scores, correction counts, and external evaluations, using a weighting rule stored in configuration information.

In one embodiment, the server performs an external search query using a search API. The server creates a query string by extracting key entities and numeric facts from a citation candidate sentence, sends the query string to an external search server, and receives external search results. The server evaluates the external search results by matching retrieved source domains against a whitelist and by analyzing agreement or disagreement between retrieved snippets and the original statement. The server adjusts per-source reliability values based on the degree of external corroboration. The server aggregates per-source reliability values using a weighted average or other aggregation function to generate a reliability index for each document. The server stores the reliability index as a numeric field linked with the document record. This processing reduces the need to repeatedly perform manual fact-checking and organizes reliability evidence in a machine-readable format that can be reused across user sessions, thus improving data management and reducing repeated network calls.

In one embodiment, the server analyzes emotional expressions in document text and calculates an emotion index. The server uses an emotion dictionary that associates lexemes with emotion categories, such as positive, negative, fear, anger, and joy. The server counts occurrences and weights of emotion-bearing words in each document and computes an emotion score vector. The server further applies a neural network-based sentiment classifier, such as a recurrent neural network or a transformer-based encoder, to classify sentence-level sentiment. The server aggregates sentence-level predictions and dictionary-based scores to generate an overall emotion index that represents at least a dominant polarity and optional emotion-type probabilities. The server records the emotion index and emotion-type distribution in the structured information storage.

In one embodiment, the server integrates the bias index, reliability index, emotion index, subject information, and feature information into analysis-structured data. The server defines a structured representation, such as a JSON object or a structured record, that includes fields for document identifiers, source identifiers, topic distributions, indices, expression pattern hits, and source reliability values. The server generates analysis-structured data and stores it in a table optimized for server-client communication. The server provides the analysis-structured data via an external interface that exposes a set of endpoints. When the server responds to a request from a client terminal, the server transmits only compact analysis-structured data and not full raw text, thereby reducing communication volume and improving response time.

In one embodiment, the terminal is a user-operated computing device, such as a smartphone, tablet, or personal computer, which includes a display, an input device, a network interface, and a local processor. The terminal receives analysis-structured data from the server through the external interface, parses the received data using a JSON parser or equivalent, and generates visualization information. The terminal constructs graphical displays, such as time-series plots of bias index changes, distribution charts of reliability index across topics, and correlation matrices between indices and topics. The terminal renders these graphical displays using a graphics library or a native rendering engine on the display. The terminal receives operation information, such as user selections, filter changes, or focus changes, and requests updated analysis-structured data or alters the graphical display layout accordingly. This division of work enables the terminal to focus on rendering and interaction, while the server performs heavy computation, thereby improving overall system performance and user experience.

In one embodiment, the server uses a generative AI model to maintain and refine configuration information for analysis tasks. The server establishes a communication channel with an external generative AI model through a network-based API. The server stores template prompt sentences in a configuration repository, such as:

“Please describe in detail how to detect bias in news articles by identifying specific linguistic patterns, and propose additional phrases that often indicate political or ideological bias.”

“Please explain how to compute a credibility score for news articles by combining the historical reliability of sources, agreement with other reputable outlets, and the presence of anonymous sources.”

“Please describe a method for analyzing the emotional tone of a news article and classifying it into positive, negative, or neutral categories, with attention to words indicating fear, anger, or joy.”

The server automatically generates query sentences by inserting context, such as current pattern lists or weighting rules, into these template prompt sentences. The server transmits the generated prompt sentences to the generative AI model and receives responses containing language expressions. The server parses the responses to extract candidate expression patterns, suggestions of weighting rules, and user-oriented explanatory text. The server updates a pattern table and configuration information by adding or modifying expression patterns and weight assignments, after optional validation by an operator. The server stores user-oriented explanatory text in association with analysis-structured data so that the terminal can display an explanation together with indexes and charts.

In one embodiment, the server uses the generative AI model to improve computer functioning beyond simple automation of human reading. The server uses the generative AI model to compress complex linguistic knowledge into machine-usable rules that adjust feature selection, threshold values, and weighting schemes. The server applies these updated rules directly in the bias and reliability computation modules, which reduces misclassification rate and improves adaptation to linguistic drift without rewriting program code. The server thus reduces the frequency of manual model tuning and redeployment operations, decreases configuration errors, and shortens the time between identification of new bias patterns and deployment of corresponding detection logic, leading to a technical improvement in system maintenance and robustness.

In one embodiment, the server is configured to maintain separate modules for feature extraction, topic modeling, bias calculation, reliability calculation, emotion calculation, generative model interaction, and visualization preparation. The server connects these modules through defined data structures and memory buffers, such that each module consumes and produces specific structured records. The server uses in-memory caching of intermediate features to avoid repeated computation for documents that are analyzed multiple times or for multiple indices. By caching tokenized text and topic distributions, and by reusing these results across different modules, the server reduces central processing unit load and memory access operations. Consequently, the server improves computational efficiency and response times for client requests.

In one embodiment, the server implements alternative machine learning architectures. For example, the server uses a convolutional neural network with one-dimensional convolution over token embeddings for bias classification, or uses a transformer encoder with self-attention layers. The server represents each token as a dense vector embedding, initialized with pretrained embeddings and fine-tuned during training. The server defines a loss function incorporating both classification error and regularization terms, such as L2 regularization, to improve generalization. The server trains the models using mini-batch gradient descent and a learning rate schedule, possibly incorporating early stopping based on validation metrics. These implementations provide alternative ways to realize the bias index and emotion index computations while remaining within the same inventive framework.

In one embodiment, the server can vary the way external search information is incorporated. The server may assign different weights to search results based on ranking position, domain reputation, or recency, and may compute a confidence score that influences the reliability index. The server may also support alternative data structures, such as graph representations of sources and citations, where nodes represent sources and edges represent co-citation relationships, and the server may compute reliability propagation across the graph using an iterative algorithm. These variations offer different trade-offs between computational complexity and accuracy while supporting the same overall functionality.

In one embodiment, the terminal supports offline or low-bandwidth scenarios by caching analysis-structured data and graphical representations for later display. The terminal may adapt visual complexity based on device capabilities, for example by simplifying correlation displays on small screens to conserve computational resources and power consumption. The server may adapt the size and detail level of analysis-structured data based on network conditions, sending fewer fields or lower-resolution data when bandwidth is limited, thereby reducing communication load and improving technological performance under constraints.

In one embodiment, the user interacts with the terminal to select articles, topics, or index ranges for inspection. The user may request that only documents above a threshold reliability index or below a threshold bias index be displayed. The terminal forwards these constraints to the server, and the server executes corresponding queries against the structured information storage, returning only matching analysis-structured data. This approach reduces the need to transmit large volumes of unfiltered data, improving network efficiency and server scalability. Through these embodiments, the server, the terminal, and the user cooperate in a system that not only automates content analysis but also improves core computer operations: text processing redundancy is reduced by shared feature extraction; analysis-structured data optimizes storage and transmission; adaptive machine learning models and generative AI-based configuration improve accuracy and robustness; and modular design with defined data structures enhances computational efficiency and scalability.

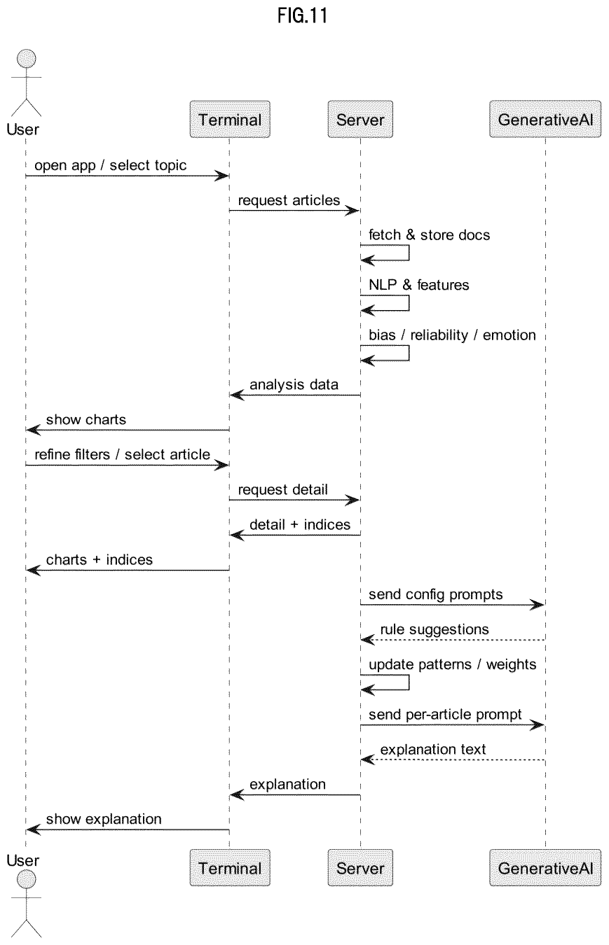

The following describes the processing flow using FIG. 11.

### Step 1:

Server receives raw document data and associated attribute data from multiple information distribution sources via a network interface.

Server takes as input HTTP responses or feed messages that contain markup text, metadata headers, and resource identifiers.

Server parses the markup text using a parsing library, removes control tags, normalizes character encoding, and extracts fields such as title text, body text, time stamp, and source identifier to produce structured document records as output.

Server stores the structured document records and associated attribute data in a structured information storage as the output of this step.

### Step 2:

Server selects newly stored document records from the structured information storage based on a processing status flag.

Server takes as input plain text fields (title and body) and attribute data (time stamp, source identifier, category flag) from each selected record.

Server applies sentence segmentation to divide the text into sentence units, and applies tokenization or morphological analysis to convert each sentence into a unit expression sequence.

Server normalizes tokens (for example, lowercasing and lemmatization), removes stop words and punctuation, and generates token lists and sentence lists as the output, storing them in a feature table.

### Step 3:

Server performs topic extraction to compute topic distributions for each document.

Server takes as input the token lists generated in Step 2 and a vocabulary mapping that assigns an index to each unique token.

Server builds a document-term matrix, applies a topic modeling algorithm, and iteratively updates topic parameters until a convergence criterion is met.

Server outputs, for each document, a topic distribution vector and subject information (one or more dominant topics) and stores these as part of the feature information.

### Step 4:

Server constructs feature vectors for bias analysis by combining linguistic and topical features.

Server takes as input the token lists, n-gram counts, topic distribution vectors, and attribute data for each document.

Server computes numerical features such as term frequency-inverse document frequency values, topic weights, and document length statistics.

Server concatenates these numerical values into a fixed-length feature vector and stores the resulting feature vector as the output for each document.

### Step 5:

Server detects occurrences of predefined bias-related expression patterns in each document.

Server takes as input unit expression sequences and a pattern table that includes phrases and regular expressions associated with bias categories.

Server scans each sequence, applies pattern matching to identify spans that match any expression pattern, and counts the frequency of each pattern.

Server outputs a pattern occurrence vector and a list of matched spans (with sentence index and character offsets) and stores them in a bias-detection record linked to the document.

### Step 6:

Server calculates a bias index for each document using a trained classification model.

Server takes as input the feature vector from Step 4 and the pattern occurrence vector from Step 5.

Server feeds the concatenated input into a neural network or other classification model, performs matrix multiplication and non-linear activation operations, and computes an output bias probability.

Server scales and thresholds the bias probability to generate a numeric bias index and a categorical bias label as output and stores them with the document record.

### Step 7:

Server identifies citation candidate sentences that refer to information sources.

Server takes as input the sentence list and token annotations for each document.

Server searches for citation indicators, such as quotation punctuation and reporting verbs, and marks sentences that satisfy rule-based patterns as citation candidate sentences.

Server outputs a subset of sentences flagged as citation candidates and associates them with the corresponding document in a citation table.

### Step 8:

Server performs entity recognition and name normalization for information sources.

Server takes as input the citation candidate sentences from Step 7.

Server applies an entity recognition model to label spans as organizations, persons, or publications, and extracts raw entity names.

Server normalizes the raw names using text normalization rules and an alias mapping table to generate canonical source identifiers as output and stores them with the citation information.

### Step 9:

Server computes per-source reliability values from historical records and external search evidence.

Server takes as input the canonical source identifiers from Step 8 and accesses a reliability database containing past reliability records.

Server retrieves historical metrics (such as accuracy scores, correction counts, and evaluation flags) and combines them using a configured weighting rule to compute a base reliability value.

Server optionally issues external search queries, compares retrieved snippets to the original claim, and adjusts the base reliability value according to corroboration or contradiction, outputting a final reliability value for each source.

### Step 10:

Server aggregates per-source reliability values to calculate a document-level reliability index.

Server takes as input the list of cited sources and their reliability values from Step 9 for each document.

Server applies an aggregation function, such as a weighted average where weights depend on citation frequency or source role, and computes a single reliability index per document.

Server outputs the reliability index as a numeric value and a corresponding category label and stores them in the document record.

### Step 11:

Server analyzes emotional expressions and sentiment in document text.

Server takes as input the token lists, sentence lists, and an emotion dictionary associating words with emotion categories.

Server counts emotion-bearing words, computes emotion scores per category, and applies a sentiment classification model to each sentence to obtain positive, negative, and neutral probabilities.

Server aggregates these probabilities and scores across sentences to output an emotion index vector and a dominant sentiment label and stores them as part of the analysis data.

### Step 12:

Server integrates multiple analytic outputs into analysis-structured data.

Server takes as input for each document the subject information, feature information, bias index, reliability index, emotion index, matched patterns, and cited sources.

Server organizes these values into a structured record with defined fields, serializes the record into a compact representation, and stores it in an analysis table prepared for external access.

Server outputs the analysis-structured data when responding to client requests.

### Step 13:

Terminal requests analysis-structured data and renders visualization information.

Terminal takes as input user selections such as selected articles, topics, or index filters.

Terminal sends a request to the server specifying identifiers and filter parameters, receives analysis-structured data in response, and parses the data into internal objects.

Terminal generates graphical displays, such as time-series charts of indices, distribution charts of bias index and reliability index, and correlation plots between indices and topics, and outputs these visual elements on a display device.

### Step 14:

User interacts with graphical displays to refine viewing conditions.

User takes as input the visible charts and indicators presented on the terminal screen.

User performs operations such as tapping a chart element, adjusting a slider for bias index range, or selecting a topic label, and the terminal converts these actions into operation information.

User thereby changes the subset of documents or indices being shown, and the terminal outputs updated visualization information by either reusing cached analysis-structured data or requesting additional data from the server.

### Step 15:

Server generates prompt sentences for interaction with a generative AI model.

Server takes as input current configuration information, including existing expression patterns, weighting rules, and performance metrics.

Server fills template strings with context-specific details to produce prompt sentences, such as a prompt for bias detection rules, a prompt for reliability scoring schemes, and a prompt for emotion analysis guidelines.

Server outputs these prompt sentences as text and prepares them for transmission to the generative AI model via an API call.

### Step 16:

Server transmits prompt sentences to the generative AI model and receives responses.

Server takes as input the prompt sentences from Step 15.

Server sends the prompt sentences over a network connection to a remote generative AI service and receives response texts that contain candidate rules, new phrases, and explanation examples.

Server outputs the response texts for further parsing and analysis and stores them in a temporary configuration buffer.

### Step 17:

Server extracts analysis rule candidates and updates configuration information.

Server takes as input the response texts from the generative AI model.

Server applies parsing and pattern extraction logic to identify new expression patterns, weighting suggestions, and user-oriented explanatory sentences, and validates them according to predefined constraints.

Server updates the pattern table and weighting rules stored in configuration information with accepted candidates and outputs updated parameters that will be used in subsequent executions of the bias index and reliability index calculations.

### Step 18:

Server generates user-oriented explanatory text for documents using the generative AI model.

Server takes as input document-specific analysis-structured data, including indices, key patterns, and source reliability values.

Server constructs a prompt sentence that includes this data and a request to summarize the reasons for the assigned indices in natural language, and sends the prompt to the generative AI model.

Server receives an explanation text and outputs it by attaching it to the corresponding document's analysis record so that the terminal can display the explanation together with the visualizations.

### Step 19:

Terminal displays explanatory text together with graphical displays.

Terminal takes as input analysis-structured data and the associated explanatory text from the server.

Terminal arranges the visual charts on the display and places the explanatory text near the relevant charts or under a detail view for the selected document.

Terminal outputs a combined view that allows the user to see numeric indices, visual trends, and textual explanations in a single interface.

### Step 20:

User reviews indices, visualizations, and explanations to evaluate documents.

User takes as input the combined view rendered on the terminal, including charts, indices, and explanation text.

User interprets the displayed information and may decide to trust, question, or further investigate particular documents based on observed bias indices, reliability indices, emotion indices, and the accompanying explanations.

User optionally adjusts filters or selection criteria on the terminal, which results in new input for the terminal and subsequent processing in earlier steps.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional content analysis systems that evaluate bias, reliability, and sentiment of textual information typically implement separate and static processing pipelines. These systems often rely on fixed rule sets and manually curated dictionaries for biased expressions and sentiment terms, and they use coarse-grained source lists for reliability evaluation. As a result, such systems suffer from several technical shortcomings when deployed in large-scale, dynamic network environments.

First, existing systems generally do not generate or maintain a unified, machine-readable representation that ties bias, reliability, and sentiment metrics to specific temporal segments of audio-derived content or specific structural segments of text-derived content. This lack of fine-grained, segment-level association makes it technically difficult to render synchronized visualizations, such as heatmaps aligned to a video timeline, in a way that is computationally efficient and responsive to user interactions.

Second, conventional systems typically perform reliability evaluation using static mappings between information sources and coarse reliability scores, without systematically integrating historical reliability records with automatic cross-checking of factual statements against external information providers. This results in limited accuracy and adaptability, particularly when new sources appear or when previously reliable sources change behavior. From a computational perspective, the absence of an integrated reliability history management mechanism and factual cross-verification workflow leads to repeated, inefficient queries and fragmented data structures, which degrade performance and scalability.

Third, known systems generally do not employ a generative AI model as an adaptive component of the analysis pipeline. Existing approaches rarely use prompt-driven interaction with a generative model to automatically refine dictionaries of biased expressions, adjust reliability calculation parameters, or update sentiment scoring parameters. Without such adaptive updating, the analytical components tend to become outdated and require frequent manual reconfiguration, which is error-prone and computationally inefficient.

Fourth, most systems treat user feedback merely as a display element or a separate logging function, rather than a first-class input for updating the underlying machine-learned models and explanation mechanisms. In particular, conventional architectures do not integrate user feedback, analytical metrics, and generative model outputs into a unified data flow that can improve both the prediction quality and the generated explanations over time. This leads to a technical gap between the internal model behavior and the explanations presented to users, and prevents the system from self-improving its models and explanation data in a structured manner.

Accordingly, there is a need for an improved computer-implemented system that: (i) constructs unified visualization data linking segment-level bias, reliability, and sentiment metrics to temporal or structural indices; (ii) performs integrated reliability evaluation based on both historical reliability records and automated cross-verification of factual statements; (iii) adaptively refines bias, reliability, and sentiment calculation rules by interacting with a generative AI model using prompt sentences; and (iv) incorporates user feedback as learning data to update determination models and explanation data. Such a system should enhance computational efficiency, scalability, adaptability, and transparency of bias, reliability, and sentiment evaluation in network-based content analysis.

The specific processing by the specific processing unit 290 of the data processing device 12 in Application Example 1 is realized by the following means.

The present invention provides a server comprising a processor configured to analyze character information to extract subject information and feature information, detect biased expressions in the character information and calculate bias degree information, calculate reliability information based on source information and verification information contained in the character information, and analyze emotional expressions in the character information to calculate emotion degree information and emotion tendency information, integrate the subject information, the feature information, the bias degree information, the reliability information, and the emotion degree information to generate visualization data that associates the bias degree information and the emotion degree information with time information or position information corresponding to segments of the character information, and store the visualization data in a format suitable for synchronized rendering; extract citation source information and factual description information from the character information and compare the citation source information and the factual description information with reliability history information stored in an external information storage device and with verification information acquired from an external information providing device, thereby calculating reliability for each citation source information, determining correctness of the factual description information, and correcting the reliability information based on a result of the calculating and the determining; transmit a prompt sentence to a generative information processing model, acquire auxiliary information relating to biased expressions, calculation rules for the reliability information, and calculation rules for the emotion degree information from the generative information processing model, and update dictionary data of the biased expressions, calculation parameters of the reliability information, and calculation parameters of the emotion degree information based on the auxiliary information; and acquire evaluation information from a user, use the evaluation information as learning data to train or update a learning-type determination model used in calculating the bias degree information and the reliability information, transmit a prompt sentence including the evaluation information, the subject information, the bias degree information, the reliability information, and the emotion degree information to the generative information processing model to acquire explanation information, and store the explanation information as user-oriented explanation data in association with the visualization data. This enables the server to implement an adaptive and integrated analysis pipeline in which bias, reliability, and sentiment metrics are computed and maintained at a fine-grained segment level, reliability is dynamically refined by combining historical source behavior with automated factual cross-checking, calculation rules and dictionaries are continually updated through interaction with a generative AI model, and user feedback is systematically incorporated into both the underlying determination models and the explanation data, thereby improving the computational efficiency, scalability, adaptability, and transparency of computer-implemented content analysis.

The term “character information” refers to information expressed as a sequence of symbolic units, including text obtained from written documents, text converted from audio signals, and text extracted from semi-structured or unstructured digital content.

The term “subject information” refers to information indicating a main theme, topic, or primary focus of the character information, including topic labels or descriptors produced by classification or modeling of the character information.

The term “feature information” refers to information representing salient attributes of the character information, including summaries, topic classifications, important terms, key phrases, or other derived descriptors used for analysis or retrieval.

The term “biased expression” refers to a linguistic expression contained in the character information that indicates a particular viewpoint, partiality, or evaluative stance, and that is likely to influence perception of a subject in a non-neutral manner.

The term “bias degree information” refers to numerical or categorical information indicating an estimated magnitude or level of bias associated with at least a part of the character information, including scores or labels computed at a content level or a segment level.

The term “reliability information” refers to numerical or categorical information indicating an estimated trustworthiness, credibility, or accuracy of at least a part of the character information or of a source cited in the character information.

The term “emotion degree information” refers to numerical information indicating an estimated intensity or strength of one or more emotional states expressed in the character information.

The term “emotion tendency information” refers to categorical or probabilistic information indicating a predominant emotional orientation of the character information, including but not limited to positive, negative, and neutral orientations.

The term “visualization data” refers to structured data generated from analysis results, the structured data associating analytical metrics with time information or position information and being suitable for rendering graphical or other visual representations on an output device.

The term “citation source information” refers to information identifying a source referenced in the character information, including an author name, an organization name, a publication title, a network address, or any combination thereof.

The term “factual description information” refers to information contained in the character information that expresses verifiable facts, including numerical data, dates, events, or statements that can be checked against external references.

The term “reliability history information” refers to information stored in an information storage device that records past behavior of one or more sources, including historical reliability scores, corrections, retractions, or assessments of accuracy over time.

The term “external information storage device” refers to a storage apparatus or storage subsystem, local or remote, that stores data such as reliability history information and that is accessible to a processor via a communication interface.

The term “external information providing device” refers to a system or service, accessible through a communication network, that supplies verification information, reference data, or other external data used to confirm or refute factual description information.

The term “time information” refers to information indicating temporal positions or intervals associated with the character information, including timestamps, timecodes, or durations corresponding to segments of audio or video.

The term “position information” refers to information indicating structural positions within the character information, including indices of sentences, paragraphs, sections, or other structural units.

The term “generative information processing model” refers to a machine-implemented model that, in response to an input including a prompt sentence, generates output data such as natural language text, structured data, or parameter suggestions based on learned patterns.

The term “prompt sentence” refers to an input expression provided to a generative information processing model, the input expression specifying a request, instruction, or context for generating output data used to support analysis or configuration.

The term “auxiliary information” refers to information generated by the generative information processing model in response to a prompt sentence, the information being used to refine dictionaries, calculation rules, parameters, or other analytical components.

The term “dictionary data of biased expressions” refers to data structures that store one or more biased expressions, associated categories, and related metadata for use in detecting biased expressions in character information.

The term “calculation parameters of the reliability information” refers to configurable numerical values, weights, thresholds, or rule settings used by a processor to compute reliability information from source-related data and verification data.

The term “calculation parameters of the emotion degree information” refers to configurable numerical values, weights, thresholds, or rule settings used by a processor to compute emotion degree information from the character information.

The term “evaluation information” refers to information acquired from a user that indicates an assessment of bias, reliability, sentiment, or overall quality of content, and that is used as learning data for training or updating determination models.

The term “learning-type determination model” refers to a model implemented by machine learning techniques, the model being configured to output determinations such as bias degree information or reliability information based on input features derived from character information.

The term “explanation information” refers to information generated to describe or justify analysis results, including natural language text that explains reasons for bias, reliability, or sentiment assessments.

The term “user-oriented explanation data” refers to explanation information formatted, organized, or annotated so that it can be presented to a user in association with visualization data to facilitate understanding of analysis results.

In one embodiment, a server executes a program on one or more processors and memory devices to implement the system according to the claims. The server includes a central processing unit, a main memory, a non-volatile storage device, a network interface, and optionally a graphics processing unit. The server executes an operating system and middleware that support application software, including natural language processing libraries, machine learning frameworks, database management software, and web application frameworks. A terminal, such as a personal computer, a tablet device, or a mobile communication device, communicates with the server over a communication network and presents visualization data to a user. The user operates an input interface of the terminal to provide evaluation information, to select content, and to request explanations.

The server stores character information in a data storage subsystem, such as a relational database or a document-oriented database. The server stores, for each content item, a content identifier, raw character sequences, time information or position information, and analysis results including subject information, feature information, bias degree information, reliability information, emotion degree information, emotion tendency information, and visualization data. The server maintains auxiliary data structures, including a dictionary of biased expressions, reliability history information for cited sources, and parameters used for computing reliability information and emotion degree information.

The server acquires character information by using software components that convert audio information into text and by using software components that extract main body text from unstructured documents. For example, the server uses a speech recognition engine implemented as a neural network model that receives audio waveforms decoded by a multimedia framework and outputs character sequences with time-aligned tokens. The server uses a text extraction library that removes non-content elements from markup-based documents and outputs the main textual body. The server normalizes the character information by unifying character encoding, removing control characters, and segmenting the text into sentences and paragraphs based on punctuation and learned segmentation rules.

The server analyzes the character information to generate subject information and feature information by executing natural language processing software. The server loads an NLP model into the main memory, such as a transformer-based encoder implementing self-attention layers, layer normalization, and feed-forward networks. The server applies tokenization to split the character information into subword tokens, and the server generates contextual embeddings for each token using the transformer encoder. The server derives a document-level vector by pooling token embeddings and feeds this vector into a classification layer to obtain topic classification probabilities, which the server stores as part of the subject information. The server uses an extractive summarization algorithm, for example by ranking sentences using a similarity measure in the embedding space, or uses an abstractive summarization model, such as a sequence-to-sequence transformer with an encoder-decoder architecture, to generate summary information. The server extracts important term information by computing term frequency-inverse document frequency values or by ranking tokens based on attention weights produced in the transformer layers.

The server detects biased expressions and calculates bias degree information by combining rule-based processing and machine-learned determination. The server maintains dictionary data of biased expressions, where each entry includes a lexical pattern, a part-of-speech pattern, and a category label such as exaggeration, dismissal, or ad hominem. The server scans each sentence of the character information for matches with the dictionary entries using pattern matching algorithms capable of handling inflection and phrase variants. The server assigns initial bias scores to segments that contain such expressions. The server additionally applies a bias detection model implemented as a neural network classifier, for example a transformer encoder followed by a fully connected classification layer trained to output a probability that a given sentence exhibits biased language. The server constructs input features for this model by providing token sequences and attention masks, and the server computes a loss function such as cross-entropy during training. The server updates model parameters by gradient-based optimization, such as stochastic gradient descent or an adaptive method, using labeled training data that include bias annotations.

The server aggregates bias scores across segments to compute bias degree information for each content item. The server calculates one or more metrics, including an average bias score, a maximum bias score, and a distribution of bias scores over time information or position information. The server stores, for each segment, the bias degree information together with an index that identifies the segment's position within the character information, so that the visualization data can later align bias intensity with specific temporal or structural locations.

The server calculates reliability information based on citation source information and factual description information. The server extracts citation source information by applying named entity recognition algorithms to the character information. The server uses statistical sequence labeling models or neural network-based entity recognition models to identify names of organizations, publications, network addresses, and person names in the text. The server identifies factual description information, such as numerical values and event statements, by using pattern recognition over dependency parse trees and by matching domain-specific patterns, such as date formats and value-unit pairs.

The server maintains reliability history information for sources in an external information storage device. The server records, for each source, a reliability score, counts of prior corrections or retractions, and timestamps of reliability events. The server updates this reliability history information when external verification processes detect inaccuracies or confirmations. The server compares the extracted citation source information with the reliability history information using normalization and fuzzy matching of identifiers, and the server calculates a source-based reliability component by applying a scoring function that combines these historical attributes with configured calculation parameters of the reliability information, such as weights applied to event counts and decay factors for older events.

The server verifies factual description information by querying external information providing devices through a network interface. The server constructs requests to external data providers that hold reference data or verified facts and receives verification information in structured form. The server aligns the values and attributes of the factual description information with the verification information using data reconciliation algorithms. The server increases or decreases the reliability information associated with a segment or a citation source based on whether the factual description information matches, conflicts with, or is unsupported by the verification information. The server stores, for each content item and each segment, the resulting reliability information values and associated explanatory flags indicating which sources or facts contributed to the calculation.

The server analyzes emotional expressions in the character information to calculate emotion degree information and emotion tendency information. The server uses lexicon-based scoring by referencing a sentiment dictionary in which each entry associates a token or lemma with one or more emotion dimensions and polarity values. The server counts occurrences of such entries and computes aggregated scores by summing weighted contributions for each dimension. The server further uses a neural network-based sentiment classifier, for example a transformer-based model fine-tuned on labeled sentiment data. The server supplies tokenized segments as input vectors and obtains probability distributions over sentiment classes. The server combines lexicon-based scores and model-based probabilities by applying a weighting function specified as configuration parameters of the emotion degree information calculation. The server determines emotion tendency information, such as positive, negative, or neutral, by selecting the class with highest combined score or by applying threshold criteria.

The server integrates the subject information, feature information, bias degree information, reliability information, emotion degree information, and emotion tendency information to generate visualization data. The server constructs a data structure that, for each segment indexed by time information or position information, stores one or more of the following: bias score, reliability score, sentiment score, and segment-level subject labels. The server organizes this data into formats optimized for visualization, such as arrays indexed by timecode for video-derived segments or by paragraph index for text-derived segments. The server computes derived metrics needed for display, such as normalized bias intensities scaled to color ranges and cumulative reliability profiles. The server stores the visualization data in a database or in a cache device to allow low-latency access by the terminal.

The server interacts with a generative information processing model to refine dictionaries and calculation parameters. The server transmits a prompt sentence, such as “The system needs to detect biased expressions in political news. Please list typical English phrases that indicate strong bias or a dismissive attitude, and categorize them by type.” to the generative AI model exposed via an application programming interface. The server receives auxiliary information generated by the model, including candidate biased expressions and suggested categories. The server compares this auxiliary information with existing dictionary entries using similarity measures over word embeddings and edits the dictionary data of biased expressions by adding confirmed entries or updating categories. The server also sends prompt sentences that request improved formulations of reliability scoring rules, such as “Please describe a detailed procedure for evaluating the reliability of news content by assessing the historical reliability of its information sources and by cross-checking key claims with trusted data providers.” and uses the resulting auxiliary information to adjust calculation parameters of the reliability information, for example, by modifying weight values in the scoring function, and to adjust calculation parameters of the emotion degree information, such as class boundaries or aggregation weights.

The server acquires evaluation information from the user through the terminal. The user views visualization data, including bias heatmaps and reliability graphs, and inputs ratings or feedback regarding perceived bias, trustworthiness, or emotional tone. The terminal sends this evaluation information to the server. The server stores the evaluation information in association with content identifiers and segment indices. The server incorporates the evaluation information into learning-type determination models by adding it as labeled data. The server trains or updates the neural network models used for bias and reliability determination by executing a training process that computes a loss function, such as cross-entropy or mean squared error between model outputs and evaluation information, and updates model weights using gradient descent-based optimization. The server may apply data augmentation techniques, such as synonym replacement or sentence reordering, during training to increase robustness.

The server also uses the evaluation information together with subject information, bias degree information, reliability information, and emotion degree information to generate explanation information with the generative information processing model. The server constructs a prompt sentence, for example, “Given the following article text and the computed bias and reliability scores, please generate a concise explanation for a general user that describes why the article is considered moderately biased and how the reliability score was determined.” The server includes in the prompt the relevant analysis metrics and selected text excerpts. The server receives natural language explanation information and stores it as user-oriented explanation data linked to the visualization data. The terminal displays this explanation data to the user along with graphical elements, thereby improving user understanding of how the system computed the metrics.

The server and the terminal cooperate to achieve technical improvements that go beyond mere automation of human reading and judgment. The server constructs segment-level visualization data structures that directly associate numerical metrics with precise temporal or structural indices. This design enables the terminal to render synchronized visualizations, such as time-aligned bias heatmaps, with low computational overhead because the terminal does not need to recompute analysis results or scan the entire text during user interaction. The server reduces communication load by transmitting compact visualization data structures instead of full intermediate analysis states, and the server uses caching mechanisms to serve frequently requested visualization data rapidly.

The server improves processing accuracy and efficiency in reliability evaluation by combining reliability history information with automated fact verification. This integrated approach reduces redundant network requests and avoids reprocessing unchanged factual description information, because the server can cache verification outcomes and update only when new reference data appear. The server achieves improved bias detection accuracy by combining rule-based detection using dictionary data of biased expressions with machine-learned determination models trained on evaluation information. The server increases adaptability by periodically updating dictionary entries and model parameters using auxiliary information obtained from generative AI models, which allows the system to capture evolving language patterns and new biased expressions that would be difficult to maintain manually.

The server implements non-conventional processing flows and data structures that are specific to this system. For example, the server groups analysis metrics into visualization data units that are indexed by both segment index and metric type, which permits efficient retrieval of all metrics relevant to a portion of content. The server schedules learning updates for determination models based on accumulated evaluation information and uses configuration thresholds to trigger batch retraining or incremental parameter updates. The server uses modular architectures, where separate but interoperable components handle text normalization, topic classification, bias scoring, reliability scoring, sentiment scoring, generative model interaction, and visualization data preparation, and the server coordinates these modules through well-defined data structures and control flows.

The terminal operates as an output and interaction device that reads visualization data from the server, renders graphical representations such as heatmaps and charts, and receives user inputs. The terminal reduces its own processing requirements because the server already performs heavy computations, and the terminal can operate on a wide range of hardware configurations. The user interacts with graphical interfaces to view, filter, and evaluate content without needing to understand the internal algorithms, while the server responds by adjusting models and parameters. This arrangement leads to improved responsiveness and scalability of the overall system.

Alternative embodiments are possible within the scope of the claims. The server may use different neural network architectures for text analysis, such as recurrent neural networks or convolutional neural networks, instead of or in addition to transformer models. The server may store visualization data in in-memory data grids rather than disk-based databases to further reduce latency. The server may integrate different types of generative information processing models, including models fine-tuned for explanation generation or pattern extraction, and may vary the structure of prompt sentences accordingly. The server may implement different optimization algorithms and loss functions during training of the determination models, and may adopt various data partitioning strategies to distribute processing across multiple processors or networked servers. In all such embodiments, the server, the terminal, and the user cooperate so that the system executes a technically specific set of data structures and algorithms that improve computer-based analysis, storage, and visualization of bias, reliability, and sentiment information for content.

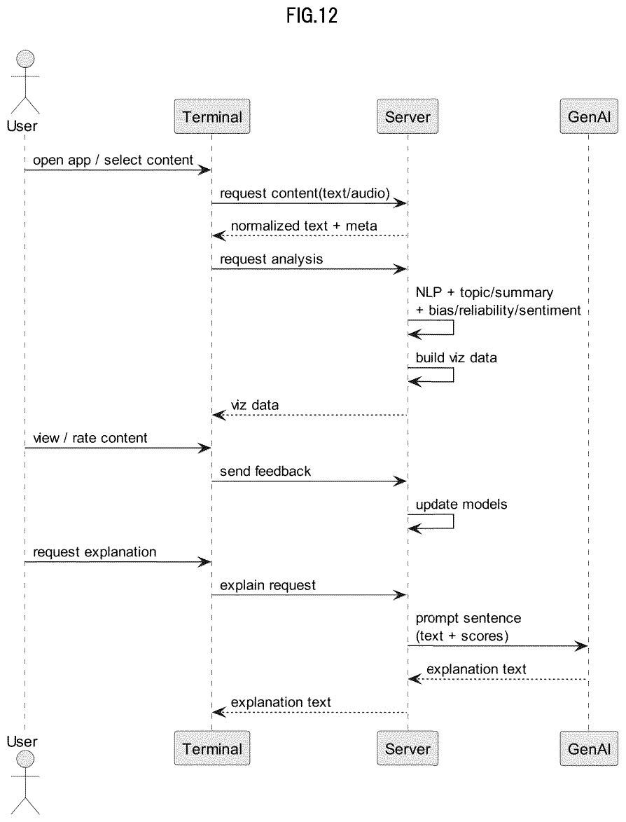

The following describes the processing flow using FIG. 12.

### Step 1: Acquisition and Normalization of Character Information

The server receives raw content data as input, including audio-visual streams, markup-based documents, and associated metadata, from external content servers via a network interface. The server converts audio streams into a standard audio format using a multimedia framework and then applies a speech recognition engine to generate character strings with time-aligned tokens. The server also applies a text extraction module to markup-based documents to remove navigation elements and advertisements, thereby extracting main body text as character information.

The server normalizes the character information by unifying encoding, removing control symbols, and segmenting the text into sentences and paragraphs based on punctuation and learned segmentation rules. As a result, the server outputs normalized character information together with structural indices and, when applicable, timecodes for each segment.

### Step 2: Generation of Subject Information and Feature Information

The server receives normalized character information and segment indices as input.

The server tokenizes the character information into subword units and feeds the tokens into a transformer-based encoder model loaded in memory, thereby generating contextual embeddings for each token. The server pools these embeddings to obtain a document vector and applies a classification layer to compute topic probabilities, which the server stores as subject information.

The server further computes feature information by executing a summarization process that ranks sentences based on similarity in the embedding space and selects representative sentences, or by calling an encoder-decoder transformer to generate an abstractive summary. The server calculates term frequency-inverse document frequency values or uses attention weights to extract important term information. The server outputs, for each content item, subject information and feature information including topic labels, summary text, and lists of important terms.

### Step 3: Detection of Biased Expressions and Calculation of Bias Degree Information

The server receives character information, segmentation indices, and dictionary data of biased expressions as input.

The server scans each sentence for matches to lexical and part-of-speech patterns stored in the biased expression dictionary, using pattern matching algorithms that account for inflection and phrase variations. When the server detects a biased expression, the server assigns an initial bias score to the corresponding segment based on the category and weight defined in the dictionary.

The server also inputs each sentence into a neural network classifier configured for bias detection, which processes token embeddings and outputs a probability that the sentence is biased. The server combines the rule-based scores and the classifier probabilities by applying a weighted averaging function to obtain a bias score for each segment. The server then aggregates segment-level scores to compute content-level bias degree information, such as average bias, maximum bias, and a distribution of bias across segments. The server outputs bias degree information linked to segment indices and content identifiers.

### Step 4: Extraction of Citation Source Information and Factual Description Information

The server receives character information and structural segmentation as input.

The server applies a named entity recognition model to identify mentions of organizations, publications, person names, and network addresses, thereby extracting citation source information. The server also parses sentences using a dependency parser and applies pattern rules to identify factual description information, including numerical values, dates, quantities, and event statements.

The server structures the extracted citation source information and factual description information into records that reference the original segment indices and content identifiers.

The server outputs these records as intermediate data for subsequent reliability evaluation.

### Step 5: Calculation and Correction of Reliability Information

The server receives citation source information, factual description information, and reliability history information from an external information storage device as input.

The server normalizes identifiers of sources (such as domain names and organization names) and performs fuzzy matching to align the extracted citation source information with entries in the reliability history storage. The server calculates a source-based reliability component by applying a scoring function that combines historical reliability scores, correction counts, and time decay parameters, thereby generating an initial reliability value for each source.

The server then queries external information providing devices to obtain verification information about the factual description information. The server compares each factual statement with the verification information and determines whether the statement is confirmed, contradicted, or unverifiable. Based on these determinations, the server adjusts the initial reliability values to produce corrected reliability information at the segment and content levels. The server outputs reliability information associated with sources, segments, and overall content.

### Step 6: Analysis of Emotional Expressions and Calculation of Emotion Degree and Emotion Tendency

The server receives character information and segment indices as input.

The server consults a sentiment lexicon to assign base scores to tokens corresponding to particular emotions and polarities and aggregates these scores for each segment. The server also inputs the tokenized segments into a sentiment classification model that outputs probabilities for sentiment categories, such as positive, negative, and neutral.

The server combines the lexicon-based scores and the model-based probabilities by applying a configured weighting scheme, thereby generating emotion degree information that represents the intensity of each sentiment dimension for each segment. The server determines emotion tendency information by selecting the dominant sentiment category or by thresholding the combined scores. The server outputs segment-level emotion degree information and emotion tendency information linked to the content identifiers.

### Step 7: Construction of Visualization Data Structures

The server receives subject information, feature information, bias degree information, reliability information, and emotion-related information as input.

The server allocates a data structure, such as a table or array, in which each entry corresponds to a segment identified by time information or position information. The server stores, in each entry, the bias score, reliability score, emotion scores, emotion tendency, and subject labels, and calculates derived metrics, such as normalized intensity values mapped to color indices. The server aggregates these segment-level entries into visualization data for each content item, including structures suitable for heatmaps, line charts, and summary indicators. The server outputs visualization data as compact records that can be transmitted to the terminal without including raw analysis model outputs.

Step 8: Interaction with a Generative AI Model for Refinement of Dictionaries and Parameters

The server receives current dictionary data of biased expressions, current calculation parameters of the reliability information and the emotion degree information, and optionally recent analysis results as input.

The server constructs a prompt sentence that specifies a refinement task, such as: “The system needs to detect biased expressions in political news. Please list typical English phrases that indicate strong bias or a dismissive attitude, and categorize them by type.” The server transmits this prompt sentence to a generative AI model via an application programming interface.

The server receives auxiliary information from the generative AI model, including candidate biased expressions, suggested categories, and potential scoring rules. The server compares the auxiliary information with existing entries and updates the dictionary data of biased expressions by adding, modifying, or removing entries according to similarity thresholds and administrator-configured policies. The server also updates calculation parameters, such as weight coefficients and thresholds used in reliability and emotion calculations. The server outputs revised dictionaries and parameter sets that are subsequently used in analysis steps.

### Step 9: Acquisition of User Evaluation Information and Model Updating

The terminal receives visualization data and explanation data from the server as input.

The terminal renders graphical elements, such as bias heatmaps, reliability graphs, and sentiment charts, and displays them to the user. The user observes these elements and inputs evaluation information, such as ratings or labels indicating perceived bias or trustworthiness, through the terminal's input interface.

The terminal transmits the evaluation information to the server. The server receives the evaluation information and associates it with content identifiers, segment indices, and previously computed metrics. The server prepares training examples by combining evaluation labels with features derived from the character information and analysis outputs. The server executes a training process that feeds these examples into learning-type determination models for bias and reliability, computes a loss function between the model outputs and the evaluation labels, and updates model weights by gradient-based optimization. The server outputs updated model parameters, which are then applied in subsequent analysis runs.

### Step 10: Generation and Presentation of Explanation Information Using a Generative AI Model

The server receives a user request for explanation via the terminal, together with identifiers of the relevant content and analysis results as input.

The server collects the associated subject information, bias degree information, reliability information, and emotion-related information, and selects representative text segments and source details. The server constructs a prompt sentence, such as: “Given the following article text and the computed bias and reliability scores, please generate a concise explanation for a general user that describes why the article is considered moderately biased and how the reliability score was determined.” The server includes the selected metrics and text excerpts in the prompt.

The server transmits the prompt sentence to the generative AI model and receives explanation information as natural language text. The server stores this explanation information as user-oriented explanation data linked to the visualization data and transmits the explanation data to the terminal. The terminal receives the explanation data and displays it alongside the graphical analysis, enabling the user to understand the reasoning behind the computed metrics.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

In networked environments, electronic processing devices increasingly acquire and present large volumes of article content, such as news items, to end users. Conventional content analysis and recommendation systems generally treat article analysis and user state modeling as static, one-directional processes. In particular, known systems typically (i) apply fixed natural language processing pipelines to compute bias or sentiment scores for each article, (ii) apply static, pre-defined formulas to compute reliability scores from citation information, and (iii) present aggregated indicators to users without dynamically adapting either the underlying models or the presentation logic to each user's emotional state.

From a computer-technology perspective, these approaches suffer from multiple technical shortcomings. First, the computation of article bias indices, reliability indices, and emotion indices is usually implemented as a fixed set of heuristics or pre-trained model outputs whose weighting and combination are hard-coded. This rigid design prevents the processor from efficiently adapting feature selection, weighting, and rule sets to new data patterns, domains, or user behaviors, and leads to sub-optimal use of computational resources because the system cannot reorganize its internal calculation logic without manual reprogramming. Second, conventional systems lack a structured mechanism by which a processor can automatically refine its own scoring and control logic through interaction with an external generative AI model. As a result, the processor cannot automatically synthesize new calculation formulas or rule sets in response to changing article characteristics or user reaction distributions, and therefore must rely on offline human tuning.

Third, conventional content-presentation systems either ignore user emotional state entirely or treat it with simple, coarse-grained flags (for example, “stressed” vs. “not stressed”), without integrating rich multimodal sensor data from a terminal device and without constructing user-specific emotion profiles that capture how a given user's emotional response depends on detailed article attributes such as topic, bias level, and sentiment tone. Consequently, the processor cannot perform fine-grained, data-driven control of warning levels and display priorities, which leads to sub-optimal information presentation and inefficient use of display resources on the terminal.

Fourth, prior systems do not provide a computer-centric architecture in which multiple analytical units—text analysis, bias index calculation, reliability index calculation, emotion index calculation, user emotion state estimation, emotion profile generation, and visualization control—are all parameterized and dynamically adjustable via structured prompt sentences and responses exchanged with a generative AI model. Without such an architecture, the processor cannot treat the generative AI model as an adaptive meta-optimizer for its own internal computational pipelines, and cannot systematically update internal parameters (features, weights, thresholds, and rule groups) based on machine-generated proposals. This results in a static system that is difficult to maintain and scale, and that does not fully exploit available computing resources and AI capabilities for improved prediction accuracy and stability.

Accordingly, there is a need for a computer-implemented system in which a processor (i) computes bias indices, reliability indices, and emotion indices for articles using modular analytical units, (ii) estimates user emotional states from multimodal terminal data, (iii) learns user-specific emotion profiles linking article attributes to predicted emotional reactions, and (iv) dynamically configures and improves these analytical and control processes through structured interaction with a generative AI model via prompt sentences. Such a system should improve the functioning of the computer itself by enabling the processor to automatically redesign and update internal calculation formulas and rule sets, to manage computational resources more efficiently, and to generate visualization outputs that are adaptively tailored to users' emotional states and sensitivities.

The specific processing by the specific processing unit 290 of the data processing device 12 in Example 2 is realized by the following means.

The present invention provides a server comprising a processor configured to execute programmed instructions stored in a memory, the processor being configured to function as a plurality of logical units including a text analysis unit, a bias index calculation unit, a reliability index calculation unit, an emotion index calculation unit, a user emotion state estimation interface unit, an emotion profile generation unit, a visualization control unit, and a generative artificial intelligence collaboration unit, and being further configured to: acquire electronic character information representing news articles from one or more data sources; perform natural language processing including morphological analysis, topic extraction, and keyword extraction to generate article attribute data; calculate, for each article, a bias index by combining outputs of a pre-trained language classification model with subjective expression frequency indicators obtained by regular expression processing and contiguous word sequence analysis; calculate, for each article, a reliability index by combining source history indicators obtained from a source history storage with content consistency indicators obtained by full-text search or document embedding similarity analysis; calculate, for each article, an emotion index by integrating lexicon-based emotion frequency indicators with probabilities output by a pre-trained emotion classification model; receive, from a terminal device, user emotion state data derived from image data, audio data, and operation log data captured while a user views an article, and store history data in which the user emotion state data is associated with corresponding article attribute data; execute a machine-learning process, including a regression model or a matrix factorization model, on the history data to generate, for each user, an emotion profile comprising user-specific parameters that predict emotional reactions to article attributes; determine, for each article, a warning level and a display priority based on the bias index, the reliability index, the emotion index, a current user emotion state, and the emotion profile, and generate visualization information data to be transmitted to the terminal device; and, as the generative artificial intelligence collaboration unit, generate natural-language prompt sentences that describe feature selection methods, weighting methods, and rule design methods for at least the bias index calculation unit, the reliability index calculation unit, the emotion index calculation unit, the emotion profile generation unit, and the visualization control unit, input the prompt sentences to a generative AI model, receive response content including proposed calculation formulas, normalization methods, weighting coefficients, and rule groups, and automatically update internal parameters and computation logic of the aforementioned units based on the response content. This enables the processor to dynamically and automatically improve internal analytical models and control rules, to enhance the accuracy and stability of bias, reliability, and emotion indices, to more precisely predict user-specific emotional reactions to articles, and to generate adaptive visualization outputs and warning controls that optimize the operation of the computer system and the presentation of information on terminal devices.

The term “system” refers to an information processing arrangement including at least one server device, at least one terminal device, and one or more storage devices, interconnected via one or more communication networks, and configured to execute the functions described herein.

The term “processor” refers to one or more hardware processing units, such as a central processing unit, a graphics processing unit, or another programmable processing circuit, configured to execute instructions to perform the operations described for the logical units of the system.

The term “memory” refers to any non-transitory computer-readable storage medium, including semiconductor memory, magnetic storage, or optical storage, that stores instructions and data used by the processor.

The term “text analysis unit” refers to a logical function executed by the processor that acquires character information of news articles, performs natural language processing such as morphological analysis, tokenization, topic extraction, and keyword extraction, and outputs structured article attribute data including subject matter, important terms, and related events.

The term “bias index calculation unit” refers to a logical function executed by the processor that inputs article text into a pre-trained language classification model, calculates a bias-related output score, analyzes article text with regular expression processing and contiguous word sequence frequency analysis to detect subjective or exaggerated expressions, and integrates these outputs to generate a numerical bias index for each article.

The term “reliability index calculation unit” refers to a logical function executed by the processor that extracts citation source candidates from article text, collates the candidates with stored source history information, calculates source history indicators, evaluates content consistency by full-text search or document embedding similarity with other articles, and combines the source history indicators and content consistency indicators to generate a numerical reliability index for each article.

The term “emotion index calculation unit” refers to a logical function executed by the processor that performs morphological analysis on article text, computes lexicon-based frequency indicators using an emotion lexicon, obtains multi-class emotion probabilities from a pre-trained emotion classification model, and integrates the lexicon-based indicators and model probabilities to output an emotion index for each article.

The term “user emotion state estimation unit” refers to a logical function executed by the processor, in cooperation with a terminal device, that receives or interfaces with image data, audio data, and operation log data captured while a user views an article, extracts image, acoustic, and behavior features using pre-defined feature extraction processes, applies a lightweight inference model to the features, and estimates scores of user emotional states, such as anger, anxiety, joy, and neutrality, associated with article identifiers and time information.

The term “emotion profile generation unit” refers to a logical function executed by the processor that stores history data linking user emotion state data with corresponding article attribute data, inputs the history data to a machine-learning process including a regression model or a matrix factorization model, and outputs, for each user, a set of user-specific parameters representing an emotion profile that predicts emotional reactions to article attributes.

The term “visualization control unit” refers to a logical function executed by the processor that receives article indices including bias indices, reliability indices, and emotion indices, receives a current user emotion state and an emotion profile, determines warning levels and display priorities for articles using rule-based or model-based inference, and generates visualization information data for transmission to a terminal device.

The term “generative artificial intelligence collaboration unit” refers to a logical function executed by the processor that creates natural-language prompt sentences describing feature selection methods, weighting methods, and rule design methods for analytical and control units, sends the prompt sentences to a generative AI model, receives response content including proposed formulas, normalization methods, weighting coefficients, and rule groups, and updates internal parameters and computation logic of the analytical and control units based on the response content.

The term “news article” refers to an electronic text content item including at least a title and a body, distributed via a communication network, and describing events or opinions related to fields such as society, politics, economics, science, technology, or culture.

The term “character information” refers to data representing textual content, including sequences of characters, symbols, or encoded tokens, that can be processed by natural language processing techniques.

The term “natural language processing” refers to a set of computational techniques for analyzing and transforming human language text, including morphological analysis, tokenization, part-of-speech tagging, syntactic parsing, topic modeling, and keyword extraction.

The term “morphological analysis” refers to processing that segments text into morphemes or tokens and assigns linguistic attributes such as part-of-speech tags to each morpheme or token.

The term “topic extraction” refers to computational processing, such as topic modeling or clustering, that identifies latent thematic structures in a collection of articles and assigns one or more topic indicators or distributions to each article.

The term “keyword extraction” refers to processing that identifies important terms or phrases in an article, for example based on frequency statistics, co-occurrence patterns, or learned importance scores.

The term “language classification model” refers to a machine-learned model, such as a neural network-based text classifier, that receives text or token sequences as input and outputs classification scores representing categories such as presence or degree of bias.

The term “pre-trained” refers to a model or parameter set that has been trained in advance on training data prior to deployment in the system and is reused or fine-tuned within the system.

The term “bias index” refers to a numerical value representing an estimated degree of bias or subjectivity of an article, computed by combining outputs of a language classification model with indicators of subjective or exaggerated expressions.

The term “subjective expression frequency indicator” refers to a numerical measure, derived from regular expression processing and contiguous word sequence analysis, representing the occurrence degree of linguistic patterns judged to be subjective or exaggerated within article text.

The term “regular expression processing” refers to pattern matching operations using formal pattern descriptions to detect specific character sequences or phrase patterns in text data.

The term “contiguous word sequence frequency analysis” refers to processing that computes frequencies of n-gram sequences or consecutive tokens in text to identify characteristic expression patterns.

The term “source history indicator” refers to a numerical or categorical value representing past reliability or performance of an information source, derived from stored source history records associated with citations in articles.

The term “content consistency indicator” refers to a measure of similarity or agreement between a target article and one or more other articles, computed for example via full-text search or document embedding similarity, and used as a factor in reliability evaluation.

The term “reliability index” refers to a numerical value representing an estimated reliability of information in an article, computed by integrating source history indicators and content consistency indicators according to a weighting scheme.

The term “emotion lexicon” refers to a stored collection of lexical entries in which words or phrases are associated with one or more emotion categories, such as positive, negative, neutral, fear, anxiety, or anger.

The term “emotion classification model” refers to a machine-learned model that receives text as input and outputs probabilities or scores for one or more emotion categories.

The term “emotion index” refers to a numerical representation of emotional tone of an article, derived from integration of lexicon-based frequency indicators and model-based emotion probabilities.

The term “terminal device” refers to a user-operated information processing device, such as a smartphone, tablet, or personal computer, that includes at least one input/output interface and is configured to display articles and visualization information and to capture user-related data.

The term “image data” refers to digital data representing visual information, including single images or sequences of frames captured by an imaging device.

The term “audio data” refers to digital data representing sound information, including sampled waveforms or compressed audio signals captured by a microphone.

The term “operation log data” refers to records of user interactions with a terminal device, including but not limited to touch events, scrolling operations, button activations, and dwell times.

The term “feature extraction” refers to computational processing that transforms raw input data, such as image, audio, or interaction data, into numerical feature vectors suitable for input into a machine-learning model.

The term “lightweight inference model” refers to a machine-learning model designed or optimized for execution with limited computational resources, for example on a mobile or embedded device, to estimate outputs such as user emotional state scores.

The term “user emotion state data” refers to data including one or more numerical scores representing a user's estimated emotional state at a given time, associated with at least an article identifier and a timestamp.

The term “history data” refers to stored records linking user emotion state data with corresponding article attribute data, including indices and topic information, accumulated over time for one or more users.

The term “emotion profile” refers to a set of user-specific parameters, learned from history data, that represents relationships between article attributes and predicted emotional reactions of a user.

The term “warning level” refers to a categorical or numerical indicator specifying a degree of caution or alert to be presented to a user with respect to viewing a given article, determined based on article indices and user emotional information.

The term “display priority” refers to a value or rank used to control placement or prominence of articles in a user interface, such as ordering in a list or emphasis in a layout.

The term “visualization information data” refers to structured data including at least article identifiers, bias indices, reliability indices, emotion indices, warning levels, and display priorities, generated for rendering in a user interface on a terminal device.

The term “generative AI model” refers to a machine-learning model, such as a large language model, configured to generate text or other structured outputs in response to natural-language input instructions.

The term “prompt sentence” refers to a natural-language instruction or query provided as input to a generative AI model, specifying a task, conditions, or desired output format.

The term “response content” refers to one or more outputs generated by a generative AI model in response to a prompt sentence, including proposals for formulas, parameters, rules, or other configuration information.

The term “rule group” refers to a set of logical conditions and associated actions that define how the system should compute indices, set warning levels, or control display priorities under specified input conditions.

In the following embodiments, a client-server configuration is described as one example. A server implements article analysis, user emotion modeling, visualization control, and collaboration with a generative AI model. A terminal implements user-side interaction, multimodal data acquisition, local inference, and presentation of visualization information. A user operates the terminal and views news articles.

Server uses one or more hardware processors (for example, a multi-core central processing unit and optionally a graphics processing unit), a main memory, a non-volatile storage device, and a network interface. Server executes a server-grade operating system, such as a Linux operating system, and runs server software components such as a web server, an application server, and a database management system (for example, a relational database or a key-value database). Server also executes natural language processing libraries (for example, a morphological analyzer, a tokenizer, a topic modeling library, and an embedding library), machine learning frameworks (for example, a deep learning framework and a classical machine learning library), and a client library for accessing an external generative AI model (for example, an application programming interface to a large language model).

Terminal uses one or more processors, memory, a display device, input devices such as a touch panel, and sensors such as a camera and a microphone. Terminal runs a mobile or desktop operating system and executes a web browser or a native application built with a user interface framework. Terminal further executes a lightweight inference engine (for example, an embedded deep learning inference library) for on-device emotion recognition.

Server stores in the storage device program modules implementing a text analysis unit, a bias index calculation unit, a reliability index calculation unit, an emotion index calculation unit, a user emotion state estimation interface unit, an emotion profile generation unit, a visualization control unit, and a generative artificial intelligence collaboration unit. Server also stores in the storage device data structures such as an article table, a source history table, a user reaction history table, an emotion profile table, and configuration tables for formulas and rules that are updated based on outputs from the generative AI model.

Server processes news article text using the text analysis unit. Server acquires article text, titles, and metadata via standardized protocols such as HTTP and stores raw article text in the article table. Server applies a morphological analyzer to split the text into tokens and to assign part-of-speech tags. Server then constructs a sparse or dense vector representation for each article, for example using term frequency-inverse document frequency weighting or document embeddings generated by a transformer-based encoder. Server applies a topic modeling algorithm, such as Latent Dirichlet Allocation or a neural topic model, implemented in a machine learning framework. Server writes to the article table fields such as topic identifiers, topic probability distributions, and extracted keyword lists. This structured representation improves the ability of subsequent modules to operate on compressed and semantically meaningful features, which reduces memory usage and accelerates downstream computations. Server calculates a bias index using a combination of model-based and pattern-based features. Server uses a sequence tokenizer compatible with a pre-trained language classification model. Server converts each article into a sequence of subword tokens and inputs the sequence into a neural network model, for example a transformer encoder with multiple self-attention layers and a classification head. Server obtains from the classification head a scalar bias logit and transforms it via a logistic function to a probability value representing model-estimated bias. Server additionally runs a regular expression engine over the article text to detect subjective patterns, such as phrases expressing absolutes or rhetorical exaggerations. Server computes a subjective expression frequency feature as the number of matched patterns normalized by the number of sentences or tokens. Server combines the model-estimated bias probability and the subjective expression frequency using a weighted formula whose coefficients are stored in a configuration table and are updatable by the generative AI model. By explicit combination of heterogeneous features, server achieves improved robustness to domain shift and reduces variance compared to relying only on one type of feature.

Server computes a reliability index by fusing source-based and content-based indicators. Server uses regular expressions and tokenization to detect citation markers and to extract candidate names of organizations or persons that serve as information sources. Server normalizes source strings using a normalization module, for example by lowercasing, removing titles, and resolving abbreviations. Server uses the normalized source name as a key into the source history table, retrieving attributes such as historical error count, domain expertise categories, and third-party evaluation scores. Server then constructs a feature vector representing source history indicators. Server also uses a full-text search engine or an embedding-based retrieval index to retrieve a set of other articles that share similar topics or high semantic similarity. Server computes a content consistency feature by calculating cosine similarity between the target article embedding and embeddings of retrieved articles. Server integrates the source history features and the content consistency feature into a reliability index using a parametric function (for example, a linear or non-linear combination), where the function form and coefficients are configured via the generative AI collaboration unit. This combination yields a reliability index that can adapt to new sources and topics while maintaining consistency with historical patterns.

Server derives an emotion index for each article. Server applies morphological analysis to the article text and uses an emotion lexicon to count occurrences of words associated with categories such as positive, negative, neutral, fear, anxiety, and anger. Server normalizes counts by article length to form lexicon-based features. Server tokenizes the article and feeds the token sequence into a pre-trained emotion classification model, for example a transformer-based multi-label classifier, obtaining for each emotion category a probability score. Server integrates lexicon-based features and model probabilities using an integration algorithm. For instance, server can apply a formula that takes a weighted sum of model probabilities and adds a correction term when lexicon features exceed thresholds in certain categories. Server stores the resulting emotion index vector per article in the article table. Because server uses both symbolic lexicon information and continuous model outputs, the emotion index is both interpretable and resilient to rare or newly coined expressions.

Terminal acquires multimodal user data while the user views articles. Terminal, upon user consent, uses the camera to capture face images or video frames and the microphone to capture short audio segments. Terminal applies pre-configured preprocessing, such as face detection and cropping, and transforms image regions into input tensors for a facial emotion recognition model (for example, a convolutional neural network or a hybrid convolutional-transformer model). Terminal obtains probability distributions over emotions such as anger, joy, sadness, and neutrality for each frame. Terminal aggregates these probabilities over a time window using statistical measures such as mean or median. Terminal also extracts acoustic features from audio segments, such as pitch contour, energy, and spectral coefficients, and inputs them into an audio emotion recognition model that outputs scores for categories such as anger and anxiety. Terminal further records interaction data such as scroll velocity, tap frequency, and dwell time in operation logs, and applies heuristic thresholds or a small neural network to derive behavior-based agitation indicators. Terminal combines visual, audio, and behavioral features with a lightweight neural network deployed via an embedded inference engine. Terminal outputs a user emotion state record containing numerical scores for multiple emotions and the currently viewed article identifier and timestamp. Terminal transmits the record to server over a secure communication channel without transmitting raw image or audio samples, thereby reducing network load and enhancing user privacy.

Server builds and updates emotion profiles for users. Server writes each received emotion state record to the user reaction history table, associating it with the corresponding article's attributes: topic distribution, bias index, reliability index, and emotion index. Server periodically loads for each user a set of past reaction records and constructs training data pairs where the input is an article attribute vector and the target is the observed emotion score vector. Server trains a prediction model, such as a matrix factorization model or a feed-forward neural network with one or more hidden layers, to minimize an error function such as mean squared error between predicted and observed emotion scores. Server updates parameters with an optimization algorithm such as stochastic gradient descent or Adam. In a matrix factorization embodiment, server represents each user with a latent vector and each article or article attribute pattern with another vector, and trains these vectors so that their inner product approximates observed emotion scores. Server stores user latent vectors and related parameters as emotion profiles in the emotion profile table. This modeling approach compresses complex user-article relationships into concise numerical structures, enabling efficient inference and personalization in subsequent processing.

Server determines warning levels and display priorities with the visualization control unit. Server retrieves for a given user all candidate articles and their indices and retrieves the user's current emotion state and emotion profile. Server constructs feature vectors combining article indices, predicted emotional response (from the emotion profile model), and current emotion scores. Server evaluates rule groups or a trained decision model to assign a warning level and a display priority to each article. For example, server can apply a rule stating that an article with a high bias index and a low reliability index, for which the emotion profile predicts high anger response and the current anger score is above a threshold, should receive the highest warning level and a reduced display priority. Server packages these decisions with index values into visualization information data and transmits the data to terminal. By taking into account both article properties and individualized emotional responses, server reduces the probability that the user's interface will emphasize content that is likely to amplify negative emotions, thereby improving both the quality of information exposure and the stability of the interaction.

Terminal renders visualization information and responds to warning levels. Terminal receives visualization information and uses a user interface framework to draw for each article a combination of textual and graphical indicators. Terminal can display colored bars representing bias indices (for example, red for high bias and blue for low bias), icons or badges representing reliability (for example, green shield icons for high reliability), and small charts or labels indicating the article's emotion tone. Terminal also adjusts the position and styling of articles in the list based on display priorities, for example placing lower-risk, balanced articles higher in the list and grouping high-risk articles in a separate section with explanation text. When terminal detects that the user selects a high-warning article, terminal can present a dialog generated from the visualization information that includes links to alternative articles or fact-checking summaries suggested by server. Terminal logs user interactions related to warnings and alternative article choices and sends summarized logs to server, which uses them to refine models and profiles. This feedback loop, implemented with precise data structures and model updates, yields measurable improvements in recommendation quality and system responsiveness.

Server collaborates with a generative AI model to configure and refine internal computations. Server implements the generative artificial intelligence collaboration unit as a module that constructs natural-language prompt sentences encoding current analytic objectives and available features. Server, for example, may generate a prompt sentence describing current inputs for bias and reliability computation and asking for a formula to integrate them: “Please propose a concrete formula for a comprehensive news article bias score by combining contextual features from a fine-tuned transformer-based language classification model with the frequency of specific subjective or exaggerated expressions. Provide explicit weights, normalization steps, and a numerical example.”

Server sends such a prompt sentence to a generative AI model through an application programming interface and receives response content containing candidate formulas and parameter values. Server parses the response to extract usable structures, such as suggested weights and thresholds, and writes them to the configuration tables associated with the bias index calculation unit and the reliability index calculation unit. Similarly, server can send a prompt sentence such as:

“Given a news article, we have (1) the historical error rate of its cited sources, (2) a source expertise score, and (3) a content similarity score compared to other outlets. Please propose a concrete weighting and normalization method to compute an overall reliability score from 0 to 100.”

or:

“In news sentiment analysis, how should we integrate transformer-based multi-class sentiment probabilities with lexicon-based frequency indicators (positive, negative, fear-related words) to obtain a more stable sentiment score? Please provide a specific formula and parameter suggestions.”

Server stores the returned formulas and applies them programmatically in subsequent index calculations. The generative AI model thereby acts as a meta-optimizer which assists in the design of models and rules, but server retains deterministic execution over clear data structures and arithmetic operations. This architecture allows server to systematically explore non-obvious weighting schemes and rule sets that a human designer might not consider and to deploy them consistently at scale, improving computational accuracy and stability.

Server also uses prompt sentences to refine visualization policies. Server constructs prompt sentences such as:

“Using article bias scores, reliability scores, sentiment tones, a user's current emotional state, and the user's emotional sensitivity profile, list concrete rule-based policies for setting (1) a warning level shown to the user and (2) the display priority in the article list. Include explicit threshold values and example cases.”

Server receives from the generative AI model proposals for rules and thresholds. Server encodes these proposals into internal rule groups, represented as condition-action pairs in configuration tables. Server then executes these rules as part of the visualization control unit. Because server uses explicit condition evaluation and structured data, the rule execution is efficient and auditable, and server can roll back or update individual rules without rewriting core code.

Server, in each embodiment, improves computer technology in multiple ways. Server reduces communication load by having terminal perform on-device feature extraction and sending only compact emotion state representations instead of raw multimedia streams. Server improves data management by storing article attributes, user reactions, and configuration parameters in relational or structured tables optimized for query and update operations. Server enhances computational efficiency by decomposing functionality into modular units, enabling parallel execution and selective re-computation of indices only when underlying data or formulas change. Server increases prediction accuracy and reduces error rates by using the emotion profile model to adapt to individual users and by continuously updating formulas and rules based on a broad exploration of parameter space guided by the generative AI model. These improvements go beyond manual human analysis or simple automation of traditional editorial workflows, because the system reconfigures its own computational logic based on machine-generated design guidance and implements that logic in a tightly integrated, resource-aware processing pipeline.

Alternative embodiments can vary specific algorithms while maintaining the same overall architecture. Server can replace the transformer-based language model with a recurrent neural network or a convolutional text classifier, adjust feature sets from token-based to character-based encodings, or substitute different topic modeling algorithms, such as non-negative matrix factorization. Terminal can run emotion recognition models with different network architectures tailored to device capabilities. Server can train emotion profiles with factorization machines or gradient-boosted decision trees instead of a feed-forward network. In each case, server continues to use structured prompt sentences, generative AI model responses, and internal configuration tables to refine and control analytical units and visualization policies. As a result, the embodiments provide a flexible, technically grounded framework in which a generative AI model is used not as a black box replacing human judgment, but as a design tool that materially enhances the way the computer system organizes, optimizes, and executes its internal data processing operations.

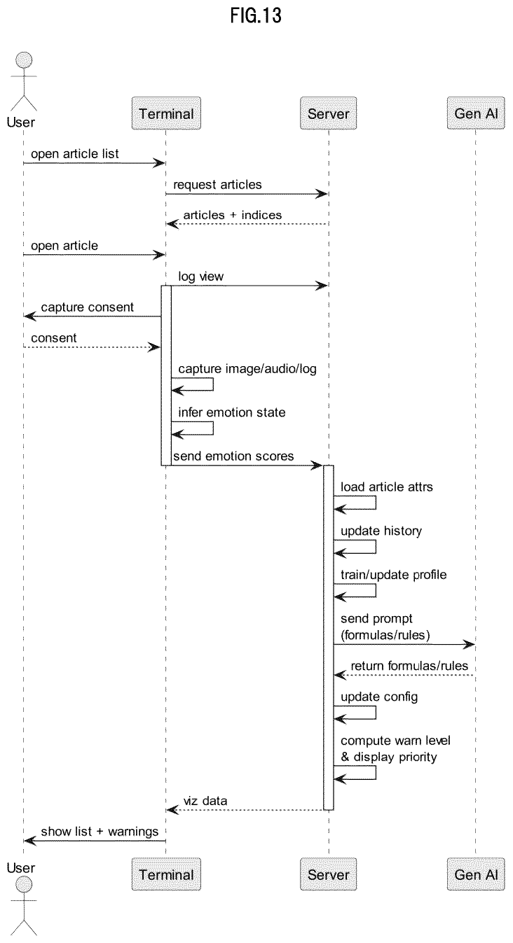

The following describes the processing flow using FIG. 13.

### Step 1:

Server acquires raw news articles and stores structured article records.

Server uses an HTTP client library to send requests to news source endpoints and receives HTML or feed data as input. Server parses the HTML or XML using a document parsing library and extracts article URLs, titles, body text, and metadata. Server compares extracted URLs against an article table in a database to filter out previously stored articles. Based on this comparison, server writes new entries that include an article identifier, source identifier, title, raw body text, publication time, and source URL as output into the article table.

### Step 2:

Server performs text analysis and generates topic and keyword attributes.

Server reads raw article text and metadata from the article table as input. Server applies a morphological analyzer to the body text to segment it into tokens and to assign part-of-speech tags. Server filters the token sequence to keep content-bearing tokens such as nouns, verbs, and adjectives and converts the filtered tokens into a vector representation using a term-weighting method or an embedding model. Server feeds the vectors to a topic modeling algorithm to estimate a topic distribution per article and uses frequency and co-occurrence analysis to determine keywords. Server writes topic identifiers, topic probability vectors, and keyword lists as output fields back to the article table.

### Step 3:

Server calculates a bias index using a language model and pattern features.

Server loads the article body text and, optionally, the token sequence from the article table as input. Server tokenizes the text with a subword tokenizer and feeds the token sequence into a pre-trained language classification neural network to obtain a bias score, such as a logit or probability representing biased expression. Server in parallel applies a regular expression engine to the raw text to detect subjective or exaggerated phrase patterns and counts occurrences normalized by text length to form a subjective expression feature. Server then performs a numerical combination, such as a weighted sum with normalization, of the model-derived bias score and the subjective expression feature to compute a final bias index. Server writes the bias index as output to a bias index field for each article in the database.

### Step 4:

Server computes a reliability index from citation sources and content consistency.

Server retrieves article text and associated citation markers from the article table as input. Server uses string processing and regular expressions to extract names of cited sources and normalizes those names (for example, by removing titles and applying case folding). Server looks up the normalized source names in a source history table to obtain source history indicators, such as error rate values and expertise scores. Server then uses a search engine or an embedding index to retrieve other articles with similar topics or content and calculates similarity values between embeddings of the target article and embeddings of retrieved articles to obtain a content consistency indicator. Server combines the source history indicators and the content consistency indicator via a configured formula (for example, a weighted linear combination) to compute a reliability index. Server outputs the reliability index by storing it in a reliability index field associated with the article.

### Step 5:

Server generates an emotion index using lexicon-based and model-based analysis.

Server reads article text and the token sequence from the article table as input. Server consults an emotion lexicon to determine which tokens correspond to emotion categories such as positive, negative, fear, anxiety, and anger, and counts their occurrences to derive lexicon-based feature values normalized by article length. Server then tokenizes the article text and feeds the tokens to a pre-trained emotion classification model, obtaining probability scores for multiple emotion categories. Server applies a predefined integration algorithm that uses both the lexicon-based features and the model probabilities, for example computing a weighted average with category-specific corrections, to produce a multi-dimensional emotion index vector. Server writes this emotion index vector as output to an emotion index field in the article table.

### Step 6:

Server interacts with a generative AI model to optimize index calculation formulas.

Server collects current input features and outputs used in the bias, reliability, and emotion index calculations from configuration tables as input. Server programmatically constructs a natural-language prompt sentence that describes available variables, such as bias probabilities, subjective expression frequencies, source error rates, content similarity scores, and lexicon frequencies, and asks for formulas and weights. For example, server may generate the following prompt sentence:

“Please propose a concrete formula for a comprehensive news article bias score by combining contextual features from a fine-tuned transformer-based language classification model with the frequency of specific subjective or exaggerated expressions. Provide explicit weights, normalization steps, and a numerical example.”

Server sends this prompt sentence to a generative AI model through an application programming interface and receives response text as output. Server parses the response text to extract formulas, normalization rules, and coefficient values and updates configuration tables that store parameters for the bias index calculation unit, the reliability index calculation unit, and the emotion index calculation unit, thereby altering how these units combine input features on subsequent runs.

### Step 7:

Terminal acquires multimodal user data while presenting articles.

Terminal receives from server a list of article summaries and associated indices as input and renders them on the display. When a user chooses to open an article and grants permissions for sensors, terminal activates a camera, a microphone, and input event listeners. Terminal captures image frames of the user's face, audio segments of the user's voice, and operation log data such as scroll motions and tap events while the article is visible. Terminal preprocesses image frames by cropping facial regions and resizing them, and converts audio into short windows and computes acoustic features. Terminal aggregates these sensor readings into time-aligned records as output for further emotion estimation.

### Step 8:

Terminal estimates the user's emotion state locally and sends compact scores.

Terminal uses a lightweight inference engine to load a facial emotion recognition model and inputs the preprocessed face images as input. Terminal obtains per-frame probabilities for emotions such as joy, anger, sadness, and neutrality, and calculates time-window averages to produce stable visual emotion scores. Terminal feeds acoustic feature vectors into an audio emotion recognition model and obtains scores for categories such as anger and anxiety. Terminal analyzes operation logs with heuristic rules or a small neural network to derive behavior-based agitation indicators. Terminal concatenates visual, audio, and behavioral features and inputs them to an on-device fusion model that outputs a vector of user emotion scores. Terminal associates this vector with the current article identifier and timestamp and constructs a user emotion state record as output. Terminal transmits the record, without raw image or audio data, to server over the network.

### Step 9:

Server builds and updates emotion profiles using reaction history.

Server receives user emotion state records from terminal as input and queries the article table to fetch article attributes for the corresponding article identifiers, including topic distributions, bias indices, reliability indices, and emotion indices. Server combines user emotion scores, article attributes, and timestamps into reaction history entries and writes them to a user reaction history table. Periodically, server selects reaction history for each user as input to a machine-learning training process. Server constructs training examples where input vectors represent article attributes and target vectors represent observed user emotion scores. Server trains a prediction model, such as a matrix factorization model or a dense neural network, by minimizing a loss function like mean squared error via gradient-based optimization. Server stores the resulting user-specific parameters, such as latent user vectors or model weights, as emotion profiles in an emotion profile table as output.

### Step 10:

Server determines warning levels and display priorities based on indices and emotion profiles. Server reads, for a particular user, the latest emotion profile and optionally the most recent emotion state record as input, along with candidate article indices from the article table. Server optionally uses the emotion profile model to predict the user's likely emotional reaction to each candidate article, generating predicted emotion scores. Server then evaluates configured rule groups or an inference model that takes as input the bias index, reliability index, emotion index, current user emotion state, and predicted emotion scores. Server applies conditional logic to assign a warning level, such as low, medium, or high, and a display priority value to each article. For example, server may assign the highest warning level and a low display priority to an article with a high bias index and low reliability index when the user's anger or anxiety score exceeds a threshold. Server writes these warning levels and display priorities into a visualization information structure as output for transmission to terminal.

### Step 11:

Server refines visualization policies with the generative AI model.

Server collects current rule groups and observed outcomes, such as user responses to warnings, from configuration and log tables as input. Server generates a prompt sentence describing existing inputs (bias index, reliability index, emotion index, current user emotion state, emotion profile) and asking for policy improvements. For example, server may construct:

“Using article bias scores, reliability scores, sentiment tones, a user's current emotional state, and the user's emotional sensitivity profile, list concrete rule-based policies for setting (1) a warning level shown to the user and (2) the display priority in the article list. Include explicit threshold values and example cases.”

Server sends the prompt sentence to the generative AI model and receives proposed rules and thresholds as response text. Server parses the response, extracts conditions and corresponding actions, and updates internal rule tables for the visualization control unit. Subsequent executions of Step 10 then use the updated rules, thus closing a feedback loop in which generative suggestions are transformed into concrete computational logic.

### Step 12:

Terminal renders visualization and supports alternative article navigation.

Terminal receives visualization information structures from server as input. Terminal uses a user interface framework to render a list of articles in which each article entry includes its title and graphical indicators derived from the bias index, reliability index, emotion index, warning level, and display priority. Terminal adjusts the order of entries or their visual prominence according to display priority values and overlays warning icons or explanatory labels for high-warning articles. When a user selects an article flagged with a high warning level, terminal detects the selection event and can display an overlay message describing the warning and offering links to alternative or fact-checking articles specified in the visualization information. Terminal records user interactions, such as whether the user chose an alternative article or proceeded to the flagged article, and sends summarized interaction logs back to server as output to be used in further refinement of emotion profiles and policies.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional content analysis and recommendation systems generally treat bias detection, source reliability assessment, sentiment analysis, and user state estimation as separate or static components. Such systems typically analyze only the content text, compute fixed bias or sentiment labels, and present these results in a simple, uniform manner to all users. As a result, these systems do not adequately adapt the presentation or prioritization of content to the current emotional state of an individual user, and do not dynamically modulate warning levels or recommendation strength in a way that mitigates potential negative impact on the user's mental state.

From a computer technology standpoint, existing systems exhibit several technical limitations. First, content analysis pipelines are often hard-coded, with rule sets and weighting parameters that are manually engineered and rarely updated. This rigidity prevents the system from efficiently incorporating new bias patterns, emerging citation sources, or nuanced emotional tone categories without substantial reprogramming and redeployment. Second, user state is usually derived from a narrow set of interaction signals, such as click history, and is not based on multimodal feature extraction that leverages imaging data, audio data, and operation log data in an integrated machine learning model. This reduces the accuracy and responsiveness of the system's internal representation of user context.

Third, conventional architectures do not provide a systematic mechanism to use a generative AI model, driven by prompt sentences, to both (i) improve internal analytical components (such as bias detection logic, reliability scoring logic, and recommendation algorithms) and (ii) generate structured, machine-readable configuration updates for these components. In many cases, generative AI output is used only as free-form text for human consumption, which does not feed back into the control logic of the content processing pipeline. As a consequence, the computing system cannot efficiently self-adapt or optimize its models and rules at runtime based on higher-level reasoning or explanations produced by the generative AI model.

Fourth, visualization mechanisms in existing systems are typically generic dashboards that do not tightly couple integrated evaluation scores—such as a combination of bias degree, reliability score, content emotion profile, and user emotional state—with fine-grained display control information. Without such coupling, the system cannot programmatically generate per-content display modes, such as differentiated warning levels, color coding, and explanation overlays, that are specifically tailored to both content characteristics and the current emotional state of the user.

Therefore, there is a need for an improved computer-implemented system in which a processor performs an integrated pipeline that: (1) analyzes text information to compute bias degrees, reliability scores, and emotion profiles; (2) estimates a user emotional state based on multimodal features from imaging data, audio data, and operation logs; (3) computes recommendation degrees and warning levels per content item by integrating these metrics; (4) generates display control information that directly governs client-side visualization; and (5) interacts with a generative AI model via prompt sentences to obtain response data that is automatically parsed and used to set or update at least part of these analytical and control processes. Such a system would improve the functioning of the underlying computer by enabling more adaptive, data-driven configuration of complex analysis pipelines without manual code changes, and by producing richer, context-aware internal states that support safer and more effective content presentation.

The specific processing by the specific processing unit 290 of the data processing device 12 in Application Example 2 is realized by the following means.

The present invention provides a server comprising a processor configured to analyze text information to extract topic information and keyword information, analyze expressions included in the text information and calculate a bias degree based on a degree of matching with a bias expression pattern, extract citation source information from the text information and calculate a reliability score by collating the citation source information with reliability data associated with the citation source information, execute an analysis process based on an emotion classification model or an emotion dictionary using the text information as input and calculate an emotion tone and an emotion profile of content data, execute a machine learning model using feature quantities extracted from imaging data, audio data, and operation log data of a user as input and estimate an emotional state of the user, calculate, for each piece of the content data, a recommendation degree and a warning level based on the bias degree, the reliability score, the emotion profile, and the emotional state of the user, generate display control information according to the recommendation degree and the warning level and control a display mode of the content data to visually present an analysis result, and transmit, to a generative machine learning model, a prompt sentence described in a natural language, acquire response data from the generative machine learning model, set or update at least a part of a bias degree calculation process, a reliability score calculation process, an emotion profile calculation process, an emotional state estimation process, or a recommendation degree and warning level calculation process based on the response data, and generate explanation text for the user. This enables the server to implement a dynamically reconfigurable content analysis and recommendation pipeline in which analytical models, scoring logic, and visualization behavior are continuously optimized based on multimodal user context and generative AI-driven configuration updates, thereby improving the technical performance, adaptability, and robustness of the underlying computer system.

The term “text information” refers to digital data representing linguistic content, including at least one of character strings, words, sentences, paragraphs, or documents, which are processed as input to natural language analysis.

The term “topic information” refers to abstracted thematic data indicating one or more main themes or subject areas of content data, derived from statistical or model-based analysis of text information.

The term “keyword information” refers to a set of representative terms or phrases extracted from text information, each associated with a relevance measure indicating its importance to the corresponding content data.

The term “bias expression pattern” refers to pattern data representing linguistic expressions characteristic of a particular viewpoint, intention, or partiality, including combinations of words, phrases, or syntactic structures, which are used to detect biased expressions in text information.

The term “bias degree” refers to a quantitative indicator, expressed as a numerical value or category, representing a level of partiality or skew in text information toward a particular position, opinion, or evaluation.

The term “citation source information” refers to data identifying external information providers referenced or quoted in content data, including at least one of names, domains, network addresses, publication identifiers, or author identifiers.

The term “reliability data” refers to stored data associated with each citation source, representing past accuracy, correction history, third-party evaluations, or similar metrics used to assess the credibility of the citation source.

The term “reliability score” refers to a quantitative indicator, expressed as a numerical value or category, representing an overall credibility of content data based on reliability data of one or more citation sources referenced in the content data.

The term “emotion classification model” refers to a trained machine learning model that receives text information as input and outputs one or more emotion categories and corresponding scores, such as positive, negative, neutral, or specific emotions.

The term “emotion dictionary” refers to a lexicon in which words or phrases are associated with one or more emotion categories and weights, used to compute emotion scores from text information.

The term “emotion tone” refers to an overall emotional tendency of content data, represented as one or more emotion categories such as positive, negative, neutral, anxious, or angry, determined from analysis of text information.

The term “emotion profile” refers to a structured feature set, such as a vector, representing intensities or frequencies of multiple emotion categories for a piece of content data.

The term “imaging data” refers to digital data acquired by an image capturing device of a terminal, including still images or moving images that may contain a user's face, facial expression, or body posture.

The term “audio data” refers to digital data representing sound captured by an audio input device of a terminal, including a user's speech and acoustic characteristics such as volume, pitch, and speaking rate.

The term “operation log data” refers to digital records of user interactions with a terminal, including at least one of touch operations, pointer movements, scroll operations, button activations, playback controls, and associated time information.

The term “feature quantities” refers to numerical representations derived from raw data, including but not limited to facial landmark coordinates from imaging data, acoustic features from audio data, and interaction metrics from operation log data, which are used as inputs to a machine learning model.

The term “emotional state of the user” refers to information indicating a psychological condition of a user, including at least one emotion category such as joy, anger, sadness, anxiety, or neutral, and a corresponding intensity or probability.

The term “recommendation degree” refers to a quantitative indicator, expressed as a numerical value or category, representing a level of priority or suitability for presenting a particular piece of content data to a user.

The term “warning level” refers to a quantitative indicator, expressed as an ordinal level or category, representing a degree of caution or warning to be displayed to a user with respect to viewing or consuming particular content data.

The term “display control information” refers to structured data specifying how content data and analysis results are to be visually presented on a terminal, including at least one of colors, icons, layouts, labels, and warning indications.

The term “display mode” refers to a visual presentation format of content data on a terminal, determined according to display control information, including arrangement, emphasis, and warning presentation.

The term “generative machine learning model” refers to a machine learning model configured to generate output data, such as text or other content, in response to input data including instructions, conditions, or prompt sentences.

The term “prompt sentence” refers to an instruction string described in a natural language or a similar expression format, which specifies desired processing content, conditions, or output format to be provided to a generative machine learning model.

The term “response data” refers to output generated by a generative machine learning model in response to a prompt sentence, including at least one of natural-language text, structured data, or configuration information.

The term “explanation text for the user” refers to natural-language text generated for presentation to a user, explaining at least one of a bias analysis result, a reliability evaluation result, an emotion tone, or a recommendation and warning decision associated with content data.

In one embodiment, a server, a terminal, and a user cooperate to implement the invention. The server is implemented on general-purpose computer hardware, such as one or more processor units, a main memory, a nonvolatile storage device, and a network interface, operating under a server operating system such as a general-purpose server OS. The server executes application software written in a high-level language such as a scripting language or a compiled language, and uses a database management system such as a relational database to store content data, user data, model configuration data, and log data. The terminal is implemented by a portable or stationary information processing device such as a smartphone, tablet, or personal computer, operating under a mobile or desktop operating system, and executes a dedicated application or a browser to communicate with the server and to acquire imaging data, audio data, and operation log data. The user operates the terminal to select topics, view content, and respond to warnings.

Server implements a text analysis function, a bias detection function, a reliability evaluation function, an emotion analysis function, a user emotion estimation function, an integrated recommendation and warning function, a visualization function, and a generative AI cooperation function as cooperating software modules. Server uses concrete software components such as an HTTP client and server library, a natural language processing library (for example, spaCy, MeCab, SudachiPy, or an equivalent), a machine learning library (for example, TensorFlow, PyTorch, or an equivalent), a multimedia processing toolkit (for example, FFmpeg or an equivalent), and a database driver for the relational database. Server executes these modules as processes or threads that exchange data via in-memory queues, shared data structures, or database tables.

Server stores text information for each piece of content data in a relational table that includes fields for content identifiers, raw text strings (such as article bodies or transcripts), language tags, and timestamps. Server stores topic information and keyword information in related tables that reference the content identifiers. Server executes a text analysis module that calls a morphological analysis engine to segment the text into words or morphemes and annotate parts of speech. Server then uses a feature vectorization module to transform the token sequence into a numerical representation, such as a term-frequency or term-frequency-inverse-document-frequency vector, implemented using a library such as a machine learning toolkit. Server further applies a topic modeling algorithm, such as Latent Dirichlet Allocation or a neural topic model, to compute topic distribution vectors for each document. Server selects the highest-probability topics as topic information and extracts the most heavily weighted terms as keyword information, and writes these results into the database.

Server implements a bias detection module that operates on the processed text and the topic metadata. Server loads a bias expression pattern set from configuration storage, where the pattern set is defined as a collection of lexical patterns and syntactic patterns, for example, fixed phrases such as “nothing more than” or “can only be described as,” and dependency patterns indicating absolute assertions. Server also loads a supervised text classification model, such as a neural network based on a transformer architecture, trained to output bias-related scores for sentences. Server converts each sentence in the text into embeddings using a text encoder, feeds the embeddings into the classifier, and obtains probability outputs for classes representing objective, subjective, and strongly biased expressions. Server simultaneously scans the sentences for explicit bias expression patterns using string matching and pattern matching. Server combines the classifier outputs and the pattern counts using a predefined numeric formula stored in configuration, such as a weighted sum with normalization. The result is a bias degree, a numeric value stored for each content item. By using both model-based probabilities and explicit lexical pattern counts, server improves robustness and allows for incremental rule updates via configuration files rather than code changes, which improves maintainability and adaptability of the computer system.

Server implements a reliability evaluation module that operates on citation source information extracted from the text. Server uses named entity recognition models, implemented for example as neural sequence labeling models, to identify citation source candidates such as names, organizations, and domains. Server normalizes these entities by mapping them to canonical identifiers using string normalization rules and lookup tables. Server then queries a “source reliability” table managed by the relational database, which stores reliability data for each source, including past error counts, correction history, external rating scores, and trust categories. Server calculates a reliability score for each content item by aggregating the reliability values of the sources using a weighting algorithm, for example, weighting by citation frequency or position in the text. Server optionally incorporates content consistency checks by comparing numerical facts in the text against external structured data sources, which further adjusts the reliability score. By using structured database tables and defined aggregation logic, server can update reliability evaluations efficiently as new sources and new ratings are added.

Server implements an emotion analysis module for content data that operates on the same text information. Server loads an emotion classification model, such as a neural network based on a transformer encoder, that outputs probabilities for multiple emotion categories including positive, negative, neutral, joy, anger, sadness, and anxiety. Server processes each sentence by converting it to embeddings and passing the embeddings to the model, then aggregates the sentence-level probabilities to obtain document-level scores. Server also maintains an emotion dictionary stored in persistent storage, where each lexeme is associated with one or more emotion categories and numeric weights. Server scans the document for these lexemes, sums or averages weights per category, and combines the dictionary-based scores with the model-based probabilities, for example using weighted averaging. Server outputs an emotion profile vector for each content item, with numerical intensities for each emotion category, and determines a dominant emotion tone, such as “anxiety-provoking” or “anger-inducing,” based on predefined thresholds. These structured outputs improve the internal representation of content emotion, enabling downstream modules to compute more precise recommendation degrees and warning levels.

Terminal acquires imaging data, audio data, and operation log data according to user consent. Terminal uses an image capture interface provided by the operating system to access a camera and periodically captures image frames. Terminal calls a face detection and landmark extraction library such as a general face processing toolkit to detect a face region and compute facial landmark coordinates. Terminal also uses an audio input interface to record audio segments containing the user's speech, and applies a digital signal processing module to compute acoustic features such as energy, pitch estimation using autocorrelation or spectral methods, and speaking rate approximations. Terminal records operation log data, such as tap counts, scroll velocities, and button activation patterns, through the user interface event handling mechanism. Terminal aggregates these measurements into feature quantities, for example by computing statistical summaries over time windows, and transmits them to server in a structured message, such as a JSON object or a binary protocol.

Server implements a multimodal user emotion estimation module that operates on these feature quantities. Server uses a neural network architecture comprising at least three subnetworks: a subnetwork for facial features, such as a fully connected network that accepts concatenated landmark coordinates; a subnetwork for audio features, such as a recurrent neural network or one-dimensional convolutional network for processing temporal sequences of acoustic features; and a subnetwork for behavior features, such as a multi-layer perceptron. Server concatenates outputs of these subnetworks into a fusion layer and applies additional fully connected layers with non-linear activation functions, leading to an output layer with softmax activation representing probabilities over emotion classes. Server trains this network in advance using labeled data, minimizing a loss function such as cross-entropy via gradient descent and backpropagation. Server may employ data augmentation methods such as random perturbation of facial landmarks or time warping of audio signals to improve generalization. At runtime, server feeds incoming feature quantities into the trained model and obtains an estimated emotional state of the user. By combining heterogeneous feature channels within a single network, server can achieve higher classification accuracy and more stable emotion estimation than methods relying solely on click history.

Server implements an integrated recommendation and warning function that consumes the bias degree, the reliability score, the emotion profile, and the estimated emotional state of the user. Server represents these values as numerical feature vectors per content item and per user. Server uses a configurable scoring algorithm, which may be implemented as a rule-based engine or a learned model such as a gradient-boosted decision tree. In a rule-based implementation, server defines for example that content items with a high bias degree and low reliability score are penalized when the user is in an anxious or angry state, whereas high-reliability content with neutral or positive emotion tone is rewarded. Server also defines discrete thresholds for determining warning levels, so that content with high negative emotion tone and low reliability score triggers a high warning level when the user's anxiety intensity exceeds a threshold. Server can store this logic as structured configuration data, such as weight matrices and threshold vectors, which allows for dynamic adjustment without modifying executable code. This arrangement enhances technical performance by separating the scoring logic from application flow, allowing the server to adapt to new patterns discovered during operation.

Server implements a visualization function that transforms internal evaluation results into display control information to be consumed by terminal. Server constructs data structures that specify, for each content item, color codes for backgrounds, icon types for reliability and bias indicators, and warning label text and placement. Server sends these structures to terminal via a network protocol. Terminal uses native UI libraries to render content lists, applying the color and icon specifications to the user interface. For example, terminal can display high-bias items with a red accent, high-reliability items with a green accent, and high-warning items with an explicit warning banner near the play button. This linkage between server-computed metrics and terminal display parameters causes a technical effect on the operation of the terminal device; the terminal adapts its rendering pipeline in real time based on processed data rather than static design, providing an improved human-machine interface.

Server implements a generative AI cooperation function using a generative AI model that is accessible via an application programming interface. Server maintains prompt sentence templates and parameter settings in configuration storage. Server generates specific prompt sentences by filling templates with content text, citation source lists, emotion profiles, or user emotion states. For bias analysis, server may generate a prompt sentence such as:

“Find all passages in the following news article that express the author's subjective opinion or show bias toward a particular political position or organization. For each passage, explain in one sentence why it can be considered biased. Output the result as pairs of passage text and reason. Article: ‘ . . . ’”

For reliability explanation, server may generate a prompt sentence such as:

“Read the following list of citation sources used in a news article. For each source, explain its reliability, mentioning any history of misinformation or frequent corrections if applicable. Output one line per source in the format: ‘Name: short reliability comment’. Sources: . . . ” For emotion explanation, server may generate a prompt sentence such as:

“Read the following news article and describe its overall emotional tone (for example: hopeful, anxiety-provoking, anger-inducing, or calm/neutral). Then quote several specific expressions from the article that most strongly contribute to that tone. Article: ‘ . . . ’” For model design or integrated logic design, server may generate a prompt sentence such as: “Design a multimodal emotion recognition model that estimates five emotions—joy, anger, sadness, anxiety, and neutral—from facial expression landmarks, acoustic features (pitch, volume, speaking rate), and touch interaction logs (tap frequency, scroll speed). Propose network architectures and feature combinations.”

Server sends these prompt sentences to the generative AI model, transmits necessary input text or structured lists, and receives response data. Server parses the responses, extracting structured information such as lists of biased passages, textual explanations, or proposed parameter settings. Server stores explanations as text fields associated with content items, which terminal can display to users. Server also transforms configuration-related suggestions into machine-readable configuration entries. For example, server may adjust weighting coefficients in the integrated scoring logic by reading recommended weight ratios from the response and writing them into configuration tables. This feedback loop allows the machine to self-adapt internal rules and model parameters in a manner not achievable by manual editing alone, improving the flexibility and evolution of the system.

Server uses specific data structures and control flows to achieve performance improvements. Server stores intermediate representations, such as bias degrees, emotion profiles, and user emotion states, in indexed tables and caches, thereby avoiding repeated computation. Server batches generative AI requests when possible, sending multiple prompt sentences in a single transaction or pooling related content texts, which reduces network overhead and latency between the server and the generative AI service. Server may precompute explanations for frequently accessed content and store them in a cache, further improving response time when users request details. Server measures processing latency for each pipeline segment and can adjust resource allocation, for example by assigning more computational threads to emotion estimation during peak usage periods.

Server improves overall computational efficiency by using dimensionality reduction on feature vectors where appropriate and by using quantized or pruned models in deployment, reducing CPU or GPU load while maintaining sufficient accuracy. Server minimizes communication load between terminal and server by encoding feature quantities in compact representations and by adjusting sampling rates of imaging and audio data depending on current processing requirements, such as reducing sampling when the emotion state is stable. These measures reflect a specific technical design to improve system performance, rather than merely automating human judgment.

User interacts with the system in a manner that causes these technical processes to be executed. User selects desired topics on the terminal, provides or denies consent for imaging and audio capture, and chooses whether to view content items that carry high warning levels. User's actions are captured as operation logs, enabling the server to refine models based on real interaction patterns. By using a combination of neural network-based analysis, explicit pattern-based rules, dynamic configuration from generative AI outputs, and tightly coupled visualization control, the system achieves improved accuracy in content evaluation, enhanced responsiveness in adapting to user emotional state, and reduced computational overhead through model and data flow optimization. These improvements are rooted in specific computer-implemented mechanisms and data structures, and they provide technical benefits beyond a mere automation of human review.

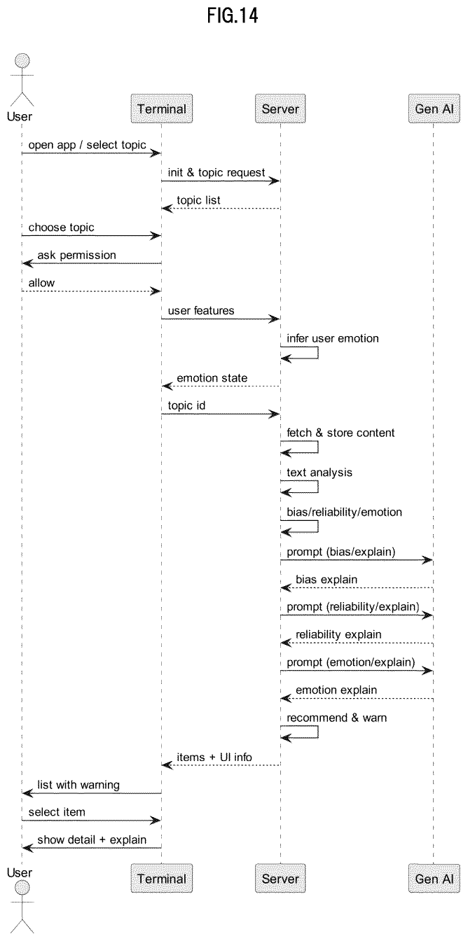

The following describes the processing flow using FIG. 14.

### Step 1:

Server receives an initial request from terminal as input, the request including at least a user identifier, device type, and one or more candidate interest topics.

Server uses this input to execute database queries against a user profile table, retrieving past viewing history, stored interest topics, and past emotional state records as intermediate data. Server performs data processing by computing topic scores, for example by counting how often each topic appears in the user's history and applying decay functions for older interactions. Based on these scores, server generates as output a ranked list of topics and a list of representative content candidates for each topic, each candidate including identifiers, titles, and basic metadata.

Server serializes this output as a structured response, such as JSON, and transmits the response to terminal over a network interface.

### Step 2:

Terminal receives the ranked topic list and content candidate metadata from server as input. Terminal parses the structured data and executes display rendering operations using a user interface framework, creating visual list items for each topic on the display. Terminal uses layout management and drawing routines to present the topics as selectable elements, such as buttons or cards.

User observes the display and, based on the visual elements, performs an explicit selection action, for example tapping a topic card.

Terminal captures this user input through its event handling mechanism, converts the selection into a topic identifier, and outputs a topic selection request containing the topic identifier and context information back to server.

### Step 3:

Terminal, upon receiving the topic selection input from user, displays a permission dialog as output, asking for consent to use camera and microphone for emotion estimation. Terminal uses operating system APIs to create and present this modal dialog.

User provides input by choosing either “allow” or “deny.”

Terminal, when the input is “allow,” configures camera and microphone using system media APIs and begins capturing imaging data and audio data as input signals. Terminal performs data processing by converting raw image frames into facial feature quantities (such as landmark coordinates) using a face detection and landmark extraction library, and by converting raw audio samples into acoustic feature quantities (such as energy and pitch) using signal processing routines. Terminal also records operation log data, such as scroll speeds and tap frequencies, and aggregates them into behavioral feature quantities.

Terminal combines facial, acoustic, and behavioral feature quantities into a structured user emotion feature packet as output and transmits this packet to server.

### Step 4:

Server receives the user emotion feature packet from terminal as input and enqueues the packet in an internal processing queue.

Server retrieves the packet from the queue and decomposes it into separate facial feature vectors, acoustic feature sequences, and behavioral feature vectors. Server then executes a multimodal emotion recognition model, implemented for example as a combination of fully connected layers, recurrent layers, and fusion layers.

Server processes the facial features through a facial subnetwork to produce intermediate embeddings, processes the acoustic features through a temporal subnetwork to produce temporal embeddings, and processes behavioral features through a dense network to produce behavior embeddings. Server concatenates these embeddings and computes, via matrix multiplications and activation functions, probability values over predefined emotion categories.

Server outputs an estimated emotional state of the user, including a main emotion label and intensity values, stores this state into a user emotion history table, and sends a compact emotional state indicator back to terminal as output.

### Step 5:

Server receives the topic selection request from terminal as input, the request specifying a particular topic identifier.

Server executes content collection procedures by building query parameters based on the topic and sending these parameters to external content provider interfaces using HTTP requests. Server receives response data as input from these providers, including article metadata and references to media files.

Server parses this response data, extracts fields such as titles, descriptions, URLs, and source identifiers, and writes these as content metadata records in a relational database. For video items, server downloads or accesses audio streams and processes them using a multimedia tool to extract audio tracks. Server then calls an automatic speech recognition service with the audio as input and receives text transcripts as output.

Server associates each transcript with a corresponding content record and stores the transcripts as text information in a dedicated table.

### Step 6:

Server reads text information for each content item from the database as input and executes a text analysis module.

Server applies tokenization and morphological analysis to convert raw text strings into sequences of tokens annotated with part-of-speech tags. Server further applies feature vectorization, such as term-frequency-inverse-document-frequency transformation, to generate numerical feature vectors representing the content.

Server then executes a topic modeling algorithm using these feature vectors as input, computing topic distributions and selecting the most relevant topics. Server also selects top-weighted terms as keyword information.

Server outputs topic information and keyword information for each content item and writes them back into content metadata records in the database.

### Step 7:

Server retrieves processed text and associated metadata as input for a bias detection module. Server executes a pre-trained text classification model, feeding each sentence as input to obtain bias-related scores (such as probabilities for objective, subjective, or biased classes). Server also loads bias expression patterns from configuration and applies pattern matching to text sentences to detect specific biased phrases.

Server combines classifier outputs and pattern detection results by performing weighted summations and normalizations on the bias scores. This computation yields a bias degree value for each content item.

Server stores the bias degree as an output field in the content metadata table and, in parallel, prepares input for a generative AI model by formatting the content text into a prompt sentence.

### Step 8:

Server generates a prompt sentence for bias explanation as an output based on the content text, for example:

“Find all passages in the following news article that express the author's subjective opinion or show bias toward a particular political position or organization. For each passage, explain in one sentence why it can be considered biased. Output the result as pairs of passage text and reason. Article: ‘ . . . ’”

Server transmits this prompt sentence and the article text as input to a generative AI model via an application programming interface.

Server receives response data from the generative AI model as output, the response containing biased passages and associated explanations. Server parses this response, extracting the text passages and reasons, and stores them in a bias explanation table linked to the corresponding content item.

Server thus enriches internal bias analysis with human-understandable explanations that are later used in visualization.

### Step 9:

Server retrieves citation source information from text analysis results as input, including names, organizations, and domain identifiers.

Server queries a source reliability table, using citation identifiers as keys, and obtains reliability data for each source as intermediate input. Server applies an aggregation algorithm to compute a content-level reliability score by combining per-source reliability values with weights based on citation frequency and prominence.

Server outputs a numerical reliability score per content item and stores it in content metadata. Server generates a prompt sentence for a generative AI model to explain source reliability, for example:

“Read the following list of citation sources used in a news article. For each source, explain its reliability, mentioning any history of misinformation or frequent corrections if applicable. Output one line per source in the format: ‘Name: short reliability comment’. Sources: . . . ” Server sends this prompt and the list of sources as input to the generative AI model, receives explanatory text as output, and stores this explanatory text associated with each content item.

### Step 10:

Server retrieves content text as input for emotion analysis and loads an emotion classification model and an emotion dictionary.

Server processes each sentence through the emotion classification model to obtain sentence-level probabilities for emotion categories. Server also scans the text to count occurrences of emotion-labeled words from the emotion dictionary and calculates lexical emotion scores. Server combines model-based probabilities and dictionary-based scores by weighting and summing them to generate an emotion profile vector for each content item, indicating intensity for each emotion category. Server determines a dominant emotion tone from this profile based on predefined thresholds.

Server stores the emotion profile and emotion tone as output in content metadata, and optionally generates a prompt sentence to obtain a descriptive explanation from a generative AI model, such as:

“Read the following news article and describe its overall emotional tone (for example: hopeful, anxiety-provoking, anger-inducing, or calm/neutral). Then quote several specific expressions from the article that most strongly contribute to that tone. Article: ‘ . . . ’”

Server sends this prompt and text as input and stores the explanatory output returned by the generative AI model.

### Step 11:

Server collects, as input, the bias degree, reliability score, emotion profile for each content item, and the latest estimated emotional state of the user from the user emotion history.

Server executes an integrated evaluation algorithm that computes recommendation degrees and warning levels. Server represents each content item and user state as feature vectors and applies a scoring model or rule set that adjusts content scores based on content bias, reliability, and emotional compatibility with the user's current state. For example, server reduces scores for low-reliability and highly negative content when the user is anxious.

Server outputs a recommendation degree and a warning level for each content item and stores these values in in-memory data structures or database tables for later retrieval.

Server may also generate internal prompt sentences describing current rules and observed outcomes, and send these as input to a generative AI model to obtain suggested adjustments to weights and thresholds, which server parses and writes into configuration fields as updated scoring parameters.

### Step 12:

Server retrieves evaluation results and explanatory texts as input for visualization. Server constructs display control information for each content item, including fields specifying color codes based on bias and reliability, icon types based on reliability categories, and warning label text and severity based on warning levels.

Server outputs this display control information as a structured response to terminal.

Terminal receives the display control information as input and uses UI rendering logic to draw content cards, set their background colors, place icons, and overlay warning labels.

Terminal integrates explanatory texts from server into detail views, so that when user opens a content item, terminal can show explanations such as “This article uses anxiety-provoking expressions like . . . ” or “This source has a history of frequent corrections.”

User views the rendered interface and, based on the bias indicators, reliability icons, and warning labels, decides whether to select or skip particular content. Terminal captures these user actions as operation log data and outputs them back to server, where server stores them for future model refinement and rule adjustment.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

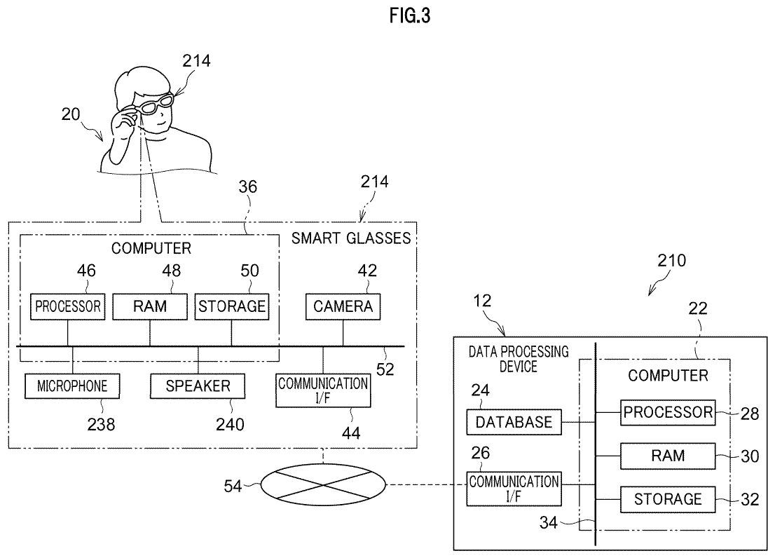

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

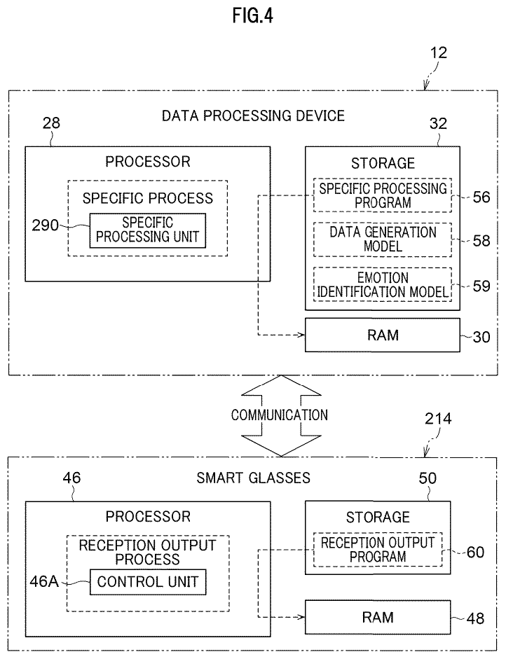

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

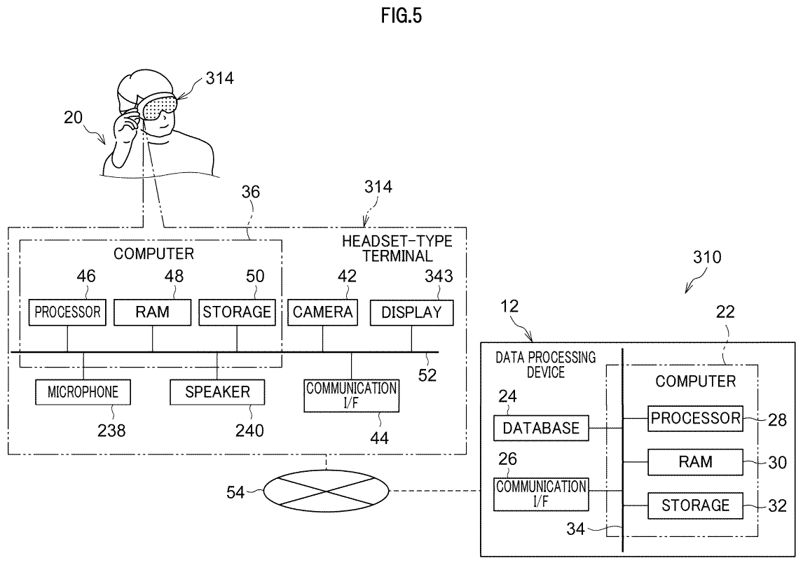

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

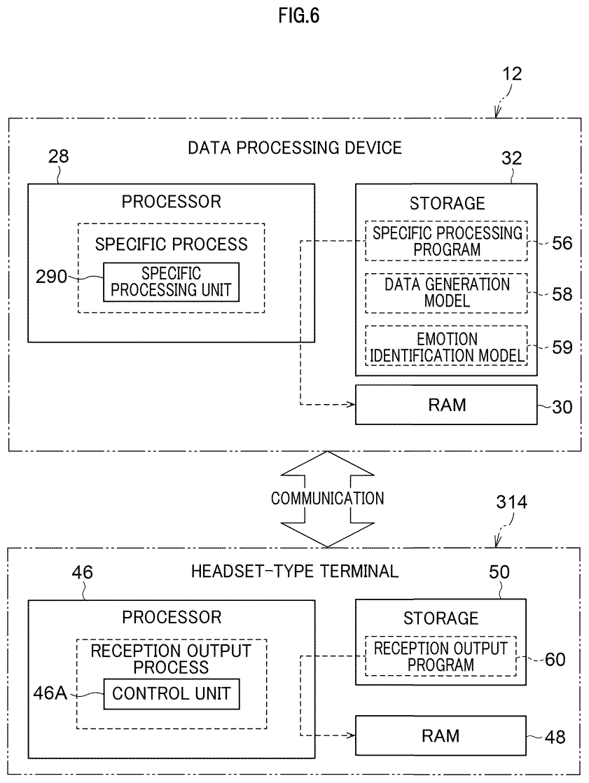

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

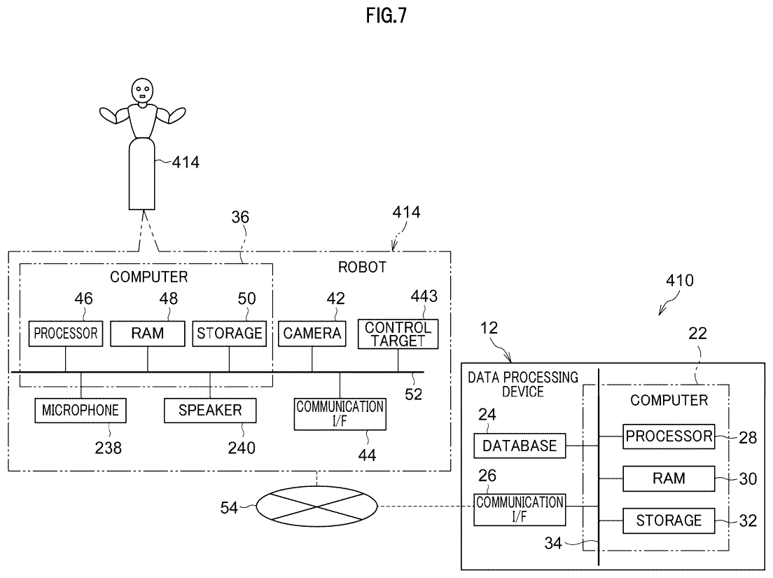

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

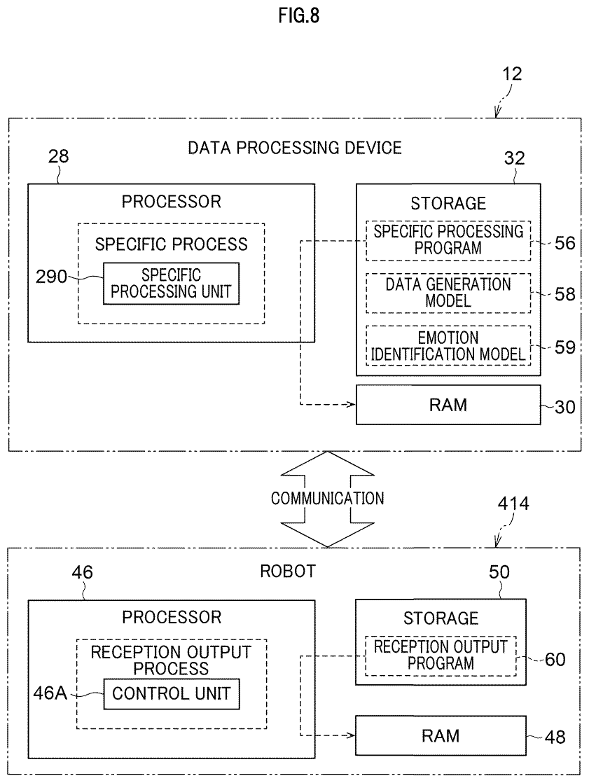

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

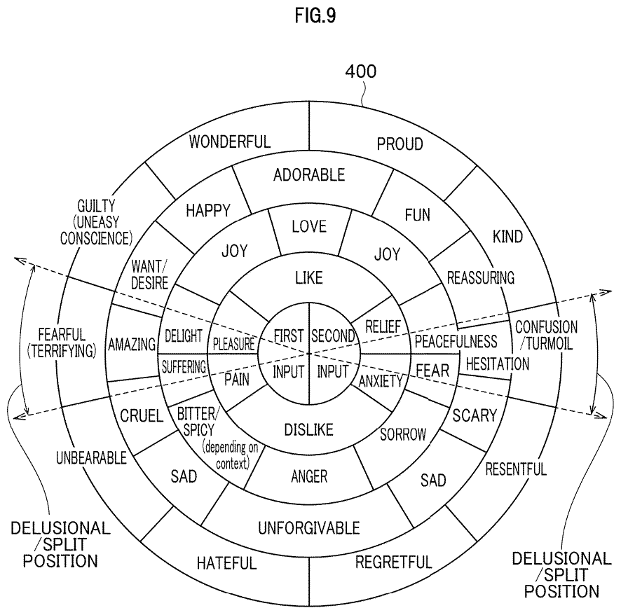

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

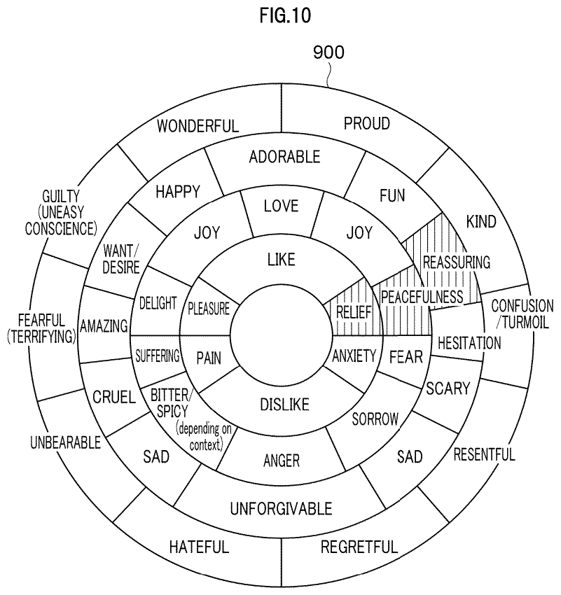

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
acquire and pre-process information data by obtaining document data and associated attribute data from a plurality of information distribution sources via an electronic communication network and storing the document data and the associated attribute data in a structured information storage,
analyze article content by performing natural language processing on text included in the document data to generate subject information and feature information, including performing morphological analysis to obtain unit expression sequences, performing topic extraction to obtain topic distributions, and extracting important expressions,
calculate a bias index by analyzing language expressions in the article content based on predefined expression patterns and a trained classification model and by inputting pattern matching results and the feature information into a statistical or machine learning model to output a numerical bias degree,
identify cited information sources in the article content and calculate a reliability index by extracting citation candidate sentences, performing entity recognition and name normalization to generate source identifiers, and comparing the source identifiers with past reliability records stored in a database and with external search results to compute a reliability value that reflects consistency with other information sources,
analyze emotional expressions in the article content and calculate an emotion index by performing emotion scoring using an emotion dictionary and emotion classification using a machine learning model to determine an emotional tone including at least one of a positive tone, a negative tone, and a neutral tone, and to determine emotion types,
integrate the bias index, the reliability index, and the emotion index to generate analysis-structured data, and provide the analysis-structured data via an external interface,
receive the analysis-structured data and generate visualization information including a plurality of graphical displays that comprise at least one of a time-series display, a distribution display, and a correlation display,
generate and transmit at least one prompt sentence to a generative AI model, receive analysis rule candidates and explanatory text from the generative AI model, and update parameter information or rule information used in the calculation of the bias index and the calculation of the reliability index based on the analysis rule candidates and the explanatory text, and
control presentation of the visualization information in response to operation information from a user by switching the graphical displays on at least one of an article unit basis, a topic unit basis, and an index-range unit basis and by presenting detailed information associated with selected parts of the graphical displays.

### (Supplementary 2)

The system according to supplementary 1,
wherein the processor is configured to
acquire and pre-process the information data by periodically executing an information acquisition process that retrieves the document data and the associated attribute data from the plurality of information distribution sources, performs normalization and cleaning of the document data, and registers the document data in the structured information storage with a processing status,
and
analyze the article content by executing the natural language processing to segment the text into sentences, tokenize the sentences into unit expressions, remove non-informative expressions, compute topic distributions for each document based on a topic model, and generate the subject information and the feature information including the unit expression sequences, the topic distributions, and a set of important expressions,
and
calculate the bias index by applying the predefined expression patterns to the unit expression sequences to detect occurrence frequencies of bias-related expressions, combining the occurrence frequencies with the feature information to form input feature vectors, and inputting the input feature vectors into the trained classification model to output the numerical bias degree as the bias index,
and
calculate the reliability index by computing the reliability value for each identified information source based on the past reliability records and the external search results and aggregating the reliability values of the identified information sources according to a weighting rule to produce the reliability index for each article.

### (Supplementary 3)

The system according to supplementary 1,
wherein the processor is configured to
generate the at least one prompt sentence to the generative AI model by automatically creating multiple query sentences including a query sentence related to bias detection, a query sentence related to reliability evaluation, and a query sentence related to emotion analysis, transmit the multiple query sentences to the generative AI model, receive responses including language expressions from the generative AI model, and analyze the language expressions to extract an expression pattern set, weighting rules, and user-oriented explanatory text,
register the extracted expression pattern set and the weighting rules as configuration information of the bias index calculation and the reliability index calculation, and
store the user-oriented explanatory text in association with the visualization information so that the explanatory text is presented to the user together with the graphical displays.

### Application Example 1

### (Supplementary 1)

A system comprising a processor,
wherein the processor is configured to
analyze character information to extract subject information and feature information, detect biased expressions in the character information and calculate bias degree information, calculate reliability information based on source information and verification information contained in the character information,
analyze emotional expressions in the character information to calculate emotion degree information and emotion tendency information,
integrate the subject information, the feature information, the bias degree information, the reliability information, and the emotion degree information to generate visualization data, extract citation source information and factual description information from the character information and compare the citation source information and the factual description information with reliability history information stored in an external information storage device and with verification information acquired from an external information providing device, thereby calculating reliability for each citation source information and determining correctness of the factual description information, and correcting the reliability information based on a result of the calculating and the determining,
divide the character information based on time information or position information and store, in the visualization data, the bias degree information and the emotion degree information for each division as time-series information or structure-corresponding information,
transmit a prompt sentence to a generative information processing model, acquire auxiliary information relating to the biased expressions, calculation rules for the reliability information, and calculation rules for the emotion degree information from the generative information processing model, and update dictionary data of the biased expressions, calculation parameters of the reliability information, and calculation parameters of the emotion degree information based on the auxiliary information, and
transmit the visualization data to an external output device to provide, as display information, an evaluation result including the bias degree, the reliability, and the emotion tendency.

### (Supplementary 2)

The system according to supplementary 1,
wherein the processor is configured to
acquire the character information by using a speech recognition function that converts audio information into a character string, or by using a character string extraction function that extracts main body text from unstructured document information, and generate, as the subject information and the feature information, summary information, topic classification information, and important term information.

### (Supplementary 3)

The system according to supplementary 1,
wherein the processor is configured to
acquire evaluation information from a user, use the evaluation information as learning data to train or update a learning-type determination model used in calculating the bias degree information and the reliability information, transmit a prompt sentence including the evaluation information, the subject information, the bias degree information, the reliability information, and the emotion degree information to the generative information processing model to acquire explanation information, and store the explanation information as user-oriented explanation data in association with the visualization data.

### Example 2

### (Supplementary 1)

A system comprising a processor,
wherein the processor is configured to function as a text analysis unit, a bias index calculation unit, a reliability index calculation unit, an emotion index calculation unit, a user emotion state estimation unit, an emotion profile generation unit, a visualization control unit, and a generative artificial intelligence collaboration unit, and wherein
the processor is configured, as the text analysis unit, to acquire character information of news articles as electronic information from a communication device or a storage device, to perform natural language processing on the character information including morphological analysis to extract a sequence of words or phrases, and to perform topic extraction processing and keyword extraction processing based on a statistical model or a machine learning model, thereby specifying a subject matter of each article, important terms, and related events, and storing analysis results as article metadata in a storage device, and
the processor is configured, as the bias index calculation unit, to input the character information of each news article to a pre-trained language classification model executed on a machine learning framework, to obtain an output score relating to bias of the article from the language classification model, to perform regular expression processing and contiguous word sequence frequency analysis on the character information to calculate an occurrence degree of expression patterns determined to be subjective or exaggerated, and to integrate the output score and the occurrence degree according to a predetermined calculation formula so as to numerically calculate a bias index for each article, and
the processor is configured, as the reliability index calculation unit, to perform character string analysis and regular expression processing on the character information of each news article to extract citation source candidates, to collate the citation source candidates with source records stored in a storage device that holds source history information so as to acquire past reliability indicators of corresponding sources, to execute a search process using a full-text search engine or a document embedding vector similarity calculation process using an embedding model so as to extract other articles having the same or similar topic, to calculate a content consistency indicator based on similarity between the news article and the other articles, and to integrate the past reliability indicators and the content consistency indicator according to a predetermined weighting calculation so as to numerically calculate a reliability index for each article, and
the processor is configured, as the emotion index calculation unit, to input the character information of each news article to an emotion lexicon and a pre-trained emotion classification model, to perform morphological analysis to obtain a token sequence, to calculate, by referencing the emotion lexicon, frequency indicators of vocabulary corresponding to emotion categories including positive, negative, neutral, fear-related, anxiety-related, and anger-related vocabulary, to input the character information or a token sequence thereof to the emotion classification model to obtain probabilities for a plurality of emotion categories, and to integrate the frequency indicators and the probabilities according to an integration algorithm so as to output an emotion index for each article, and
the processor is configured, as the user emotion state estimation unit, to receive, from a terminal device, image data, audio data, and operation log data acquired while a user views a news article, to execute image feature extraction processing on the image data, acoustic feature extraction processing on the audio data, and behavior feature extraction processing on the operation log data so as to obtain feature quantities, to input the feature quantities to a lightweight inference model executed by an inference engine, and to estimate scores of user emotional states including anger, anxiety, joy, and neutrality, and to associate the estimated scores with time information and an identifier of the viewed news article and to output the association as user emotion state data, and
the processor is configured, as the emotion profile generation unit, to store, in a storage device, history data in which user emotion state data received from the user emotion state estimation unit is associated with article attributes including a topic, the bias index, the reliability index, and the emotion index corresponding to the viewed news article, to input the history data to a learning process of a regression model or a matrix factorization model, and to generate or update, as an emotion profile, a set of user-specific parameters that predicts user emotional reactions to article attributes, and
the processor is configured, as the visualization control unit, to receive, for each news article, the bias index, the reliability index, and the emotion index, and to receive a current user emotion state score and an emotion profile related to the user, to determine, by rule-based processing or inference processing using a trained model, a warning level and a display priority for each news article based on the indices, the current user emotion state score, and the emotion profile, to generate visualization information data including the warning level, the display priority, and the indices for each article, and to transmit the visualization information data to a terminal device so that the terminal device displays indicators of bias, reliability, and emotion tone and warning representations on a user interface, and
the processor is configured, as the generative artificial intelligence collaboration unit, to generate, in natural language, a prompt sentence relating to at least one of a feature selection method, a weighting method, and a rule design method used in the bias index calculation processing, the reliability evaluation processing, the article emotion analysis processing, the emotion profile learning processing, and the visualization control processing, to input the prompt sentence into a generative AI model via an interface, to obtain response content from the generative AI model, and to set or update, based on calculation formulas, weighting coefficients, or rule groups described in the response content, at least one of features, weightings, and rules used by the bias index calculation unit, the reliability index calculation unit, the emotion index calculation unit, the emotion profile generation unit, and the visualization control unit.

### (Supplementary 2)

The system according to supplementary 1,
wherein the processor is configured, as a part of the generative artificial intelligence collaboration unit and the bias index calculation unit and the reliability index calculation unit, to generate a prompt sentence that designates bias-related scores output from the language classification model, subjective expression frequency indicators obtained by the regular expression processing and the contiguous word sequence frequency analysis, source history indicators obtained from the source records, and content consistency indicators obtained from the document similarity calculation as input variables, to request, by inputting the prompt sentence to the generative AI model, candidate formulas, normalization methods, and weighting coefficients for calculating the bias index and the reliability index from the input variables, to receive, from the generative AI model, response content including specific formulas and weighting coefficients, and to automatically apply the formulas and weighting coefficients contained in the response content as computation logic of the bias index calculation unit and the reliability index calculation unit.

### (Supplementary 3)

The system according to supplementary 1,
wherein the processor is configured, as a part of the generative artificial intelligence collaboration unit and the visualization control unit, to generate a prompt sentence that requests, from the generative AI model, rule-based policy proposals for determining, based on the bias index, the reliability index, the emotion index, the current user emotion state score, and the emotion profile, the warning level and the display priority for each news article, to input the prompt sentence to the generative AI model, to receive policy proposals in response content from the generative AI model, to configure, based on the policy proposals, internal parameters defining concrete rule groups including a rule that sets the warning level to a high level when an article has a high bias index or a low reliability index and the user has a high anger score or a high anxiety score, and to control, according to the configured rule groups, warning display contents and list display order of the news articles in the visualization information data.

### Application Example 2

### (Supplementary 1)

A system comprising a processor,
wherein the processor is configured to
analyze text information to extract topic information and keyword information,
analyze expressions included in the text information and calculate a bias degree based on a degree of matching with a bias expression pattern,
extract citation source information from the text information and calculate a reliability score by collating the citation source information with reliability data associated with the citation source information,
execute an analysis process based on an emotion classification model or an emotion dictionary using the text information as input, and calculate an emotion tone and an emotion profile of content data,
execute a machine learning model using feature quantities extracted from imaging data, audio data, and operation log data of a user as input, and estimate an emotional state of the user, calculate, for each piece of the content data, a recommendation degree and a warning level based on the bias degree, the reliability score, the emotion profile, and the emotional state of the user,
generate display control information according to the recommendation degree and the warning level, and control a display mode of the content data to visually present an analysis result, and
transmit, to a generative machine learning model, a prompt sentence described in a natural language, acquire response data from the generative machine learning model, set or update at least a part of a bias degree calculation process, a reliability score calculation process, an emotion profile calculation process, an emotional state estimation process, or a recommendation degree and warning level calculation process based on the response data, and generate explanation text for the user.

### (Supplementary 2)

The system according to supplementary 1,
wherein the processor is configured to
analyze the text information by extracting words or phrases through morphological analysis, and identify a topic of an article by using a feature vectorization process and a topic model so as to clarify a theme on which the content data focuses.

### (Supplementary 3)

The system according to supplementary 1,
wherein the processor is configured to
generate the prompt sentence including a condition related to at least one of the text information of the content data, the citation source information, the emotion profile, and the emotional state of the user, transmit the prompt sentence to the generative machine learning model, analyze the response data acquired from the generative machine learning model to extract at least one of a biased expression portion and a reason therefor, a reliability explanation regarding the citation source information, a summary explanation regarding the emotion tone, and setting information regarding weighting and threshold values of a recommendation logic, and reflect an extraction result in visualization information of the content data and in an integrated evaluation logic.

What is claimed is:

1. A system comprising:
circuitry configured to:
receive, via a communication interface coupled to a packet-switched network, document data from a plurality of information distribution sources;
perform natural language processing on text information included in the document data to generate subject information and feature information by executing morphological analysis to obtain unit expression sequences and executing topic extraction to obtain topic distributions;
analyze language expressions in the text information based on predefined expression patterns and a trained classification model to output a numerical index representing a degree to which the text information emphasizes a particular viewpoint;
identify citation source entities in the text information, compare the citation source entities with records stored in a structured data store to compute a consistency value, and verify whether the citation source entities are consistent with external reference sources;
analyze emotional expressions in the text information using an emotion dictionary and an emotion classification model to determine an emotional tone; and
generate analysis-structured data integrating the numerical index, the consistency value, and the emotional tone, and transmit the analysis-structured data via an external interface for rendering as visualization information.

2. The system according to claim 1, wherein the circuitry is further configured to:
store the document data and associated attribute data acquired from the plurality of information distribution sources in a structured information storage with a processing status.

3. The system according to claim 1, wherein the circuitry is further configured to:
generate input feature vectors by combining occurrence frequencies of bias-related expressions detected by the predefined expression patterns with the feature information, and input the input feature vectors into the trained classification model to output the numerical index.

4. The system according to claim 1, wherein the text information comprises a text of a news article, and the subject information comprises a topic on which the news article focuses.

5. The system according to claim 4, wherein the circuitry is further configured to:
extract words and phrases from the text of the news article by performing the morphological analysis, and identify a subject of the news article by performing topic modeling.

6. The system according to claim 4, wherein the visualization information comprises at least a heat map indicating a degree of bias and a chart indicating the emotional tone.

7. The system according to claim 1, wherein the circuitry is further configured to:
compute the consistency value for each identified citation source entity based on past reliability records stored in the structured data store and on external search results, and aggregate the consistency values according to a weighting rule to produce an aggregated index for each document.

8. The system according to claim 1, wherein the emotional tone comprises at least one of a positive tone, a negative tone, and a neutral tone, and the circuitry is further configured to:
calculate frequency indicators of vocabulary corresponding to emotion categories by referencing the emotion dictionary, and integrate the frequency indicators with probabilities output by the emotion classification model to generate an emotion index.

9. The system according to claim 8, wherein the emotion categories further comprise at least one of a fear-related category, an anxiety-related category, and an anger-related category.

10. The system according to claim 1, wherein the circuitry is further configured to:
generate at least one prompt sentence in a natural language, transmit the at least one prompt sentence to a generative machine learning model via an interface, receive response data from the generative machine learning model, and update parameter information or rule information used in computation of the numerical index and computation of the consistency value based on the response data.

11. The system according to claim 10, wherein the circuitry is further configured to:
generate multiple query sentences including a query sentence related to bias detection, a query sentence related to reliability evaluation, and a query sentence related to emotion analysis, transmit the multiple query sentences to the generative machine learning model, and analyze language expressions in the response data to extract an expression pattern set, weighting rules, and explanatory text.

12. The system according to claim 10, wherein the circuitry is further configured to:
store the explanatory text in association with the visualization information so that the explanatory text is presented together with graphical displays.

13. The system according to claim 1, wherein the circuitry is further configured to:
receive, from a terminal device, image data, audio data, and operation log data acquired while a user views the document data, execute feature extraction processing on the image data, the audio data, and the operation log data to obtain feature quantities, input the feature quantities to an inference model, and estimate scores of user emotional states.

14. The system according to claim 13, wherein the circuitry is further configured to:
associate the estimated scores of user emotional states with time information and an identifier of the viewed document data, and output the association as user emotion state data.

15. The system according to claim 13, wherein the circuitry is further configured to:
store history data associating user emotion state data with attributes of the document data including the numerical index, the consistency value, and the emotional tone, input the history data to a learning process, and generate or update an emotion profile comprising user-specific parameters that predict user emotional reactions to document attributes.

16. The system according to claim 15, wherein the circuitry is further configured to:
determine, based on the numerical index, the consistency value, the emotional tone, a current user emotion state score, and the emotion profile, a warning level and a display priority for each document, and generate visualization information data including the warning level and the display priority.

17. The system according to claim 16, wherein the circuitry is further configured to:
set the warning level to a high level when a document has a high numerical index or a low consistency value and the user has a high anger score or a high anxiety score.

18. A system comprising:
circuitry configured to:
receive, via a communication interface coupled to a packet-switched network, document data from a plurality of information distribution sources and store the document data in a structured information storage;
perform natural language processing on text information included in the document data to generate subject information and feature information by executing morphological analysis to obtain unit expression sequences, executing topic extraction using a topic model to obtain topic distributions, and extracting important expressions to identify a subject and related entities;
analyze language expressions in the text information by applying predefined expression patterns to the unit expression sequences to detect occurrence frequencies of bias-related expressions, combining the occurrence frequencies with the feature information to form input feature vectors, and inputting the input feature vectors into a trained classification model to output a numerical index;
identify citation source entities in the text information by performing entity recognition and name normalization, compare the citation source entities with past reliability records stored in a structured data store and with external search results obtained via a search process to compute a consistency value;
analyze emotional expressions in the text information by calculating frequency indicators of vocabulary corresponding to emotion categories using an emotion dictionary, inputting the text information to a trained emotion classification model to obtain probabilities for a plurality of emotion categories, and integrating the frequency indicators and the probabilities to output an emotion index;
generate analysis-structured data integrating the numerical index, the consistency value, and the emotion index;
generate at least one prompt sentence in a natural language, transmit the at least one prompt sentence to a generative machine learning model, receive response data from the generative machine learning model, and update parameter information or rule information used in computation of the numerical index and the consistency value based on the response data; and
transmit the analysis-structured data via an external interface for rendering as visualization information comprising a plurality of graphical displays on a terminal device.

19. A method performed by circuitry, the method comprising:
receiving, via a communication interface coupled to a packet-switched network, document data from a plurality of information distribution sources;
performing natural language processing on text information included in the document data to generate subject information and feature information by executing morphological analysis to obtain unit expression sequences and executing topic extraction to obtain topic distributions;
analyzing language expressions in the text information based on predefined expression patterns and a trained classification model to output a numerical index representing a degree to which the text information emphasizes a particular viewpoint;
identifying citation source entities in the text information, comparing the citation source entities with records stored in a structured data store to compute a consistency value, and verifying whether the citation source entities are consistent with external reference sources;
analyzing emotional expressions in the text information using an emotion dictionary and an emotion classification model to determine an emotional tone; and
generating analysis-structured data integrating the numerical index, the consistency value, and the emotional tone, and transmitting the analysis-structured data via an external interface for rendering as visualization information.
